(19) United States
(12) Patent Application Publication
(10) Pub. No.: US 2025/0081144 A1
(43) Pub. Date: Mar. 6, 2025

(54) POSITIONING MODELS TRAINED USING A PLURALITY OF TYPES OF WIRELESS SIGNALS

(71) Applicant: QUALCOMM Incorporated, San Diego, CA (US)

(72) Inventors: Mohammed Ali Mohammed HIRZALLAH, San Diego, CA (US); Xiaoxia ZHANG, San Diego, CA (US); Rajat PRAKASH, San Diego, CA (US)

(21) Appl. No.: 18/457,769

(22) Filed: Aug. 29, 2023

(51) Int. Cl. H04W 64/00; G01S 5/00; G01S 5/02; H04L 5/00

(52) U.S. Cl. CPC H04W 64/00; G01S 5/0027; G01S 5/02521; H04L 5/0048

(57) ABSTRACT

A user equipment (UE) may receive a Wi-Fi positioning configuration comprising a set of measurement gaps for a reception of a set of Wi-Fi reference signals (RSs). The UE may receive the set of Wi-Fi RSs during the set of measurement gaps. The UE may measure the set of Wi-Fi RSs. The UE may calculate a position of the UE using a positioning model based on the measured set of Wi-Fi RSs. The UE may transmit a report message comprising the calculated position of the UE. The UE may receive and measure a set of UE-to-universal mobile telecommunications system terrestrial radio access network (UE-UTRAN) (Uu) RSs during a second set of measurement gaps configured by a Uu positioning configuration. The UE may calculate the position of the UE using the positioning model further based on the measured set of Uu RSs.

### TECHNICAL FIELD

The present disclosure relates generally to communication systems, and more particularly, to a positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive a Wi-Fi positioning configuration including a set of measurement gaps for a reception of a set of Wi-Fi reference signals (RSs). The apparatus may receive the set of Wi-Fi RSs during the set of measurement gaps. The apparatus may measure the set of Wi-Fi RSs. The apparatus may calculate a position of the UE using a positioning model based on the measured set of Wi-Fi RSs. The apparatus may transmit a report message including the calculated position of the UE. In some aspects, the apparatus may receive a UE-to-universal mobile telecommunications system terrestrial radio access network (UE-UTRAN) (Uu) positioning configuration including a second set of measurement gaps for a second reception of a set of Uu RSs. The apparatus may receive the set of Uu RSs during the second set of measurement gaps. The apparatus may measure the set of Uu RSs. The apparatus may calculate the position of the UE using the positioning model further based on the measured set of Uu RSs.

In an aspect of the disclosure, a method, a computer-readable medium, and an apparatus are provided. The apparatus may include a network entity, such as a location management function (LMF). The apparatus may transmit, for a user equipment (UE), a Wi-Fi positioning configuration to calculate a position of the UE based on a set of Wi-Fi reference signals (RSs). The Wi-Fi positioning configuration may include a set of measurement gaps associated with the set of Wi-Fi RSs. The apparatus may receive a report message including a calculated position of the UE based on the set of Wi-Fi RSs. The apparatus may transmit a UE-to-universal mobile telecommunications system terrestrial radio access network (UE-UTRAN) (Uu) positioning configuration to calculate the position of the UE further based on a set of Uu RSs. The Uu positioning configuration may include a second set of measurement gaps associated with the set of Uu RSs. The calculated position of the UE may be further based on the set of Uu RSs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5 is a diagram illustrating another example of positioning based on positioning signal measurements.

FIG. 6 is a connection flow diagram illustrating an example of a wireless device configured to utilize a positioning model with different types of wireless positioning signals.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to a positioning system. Some aspects more specifically relate to using a positioning model, such as an artificial intelligence (AI)/machine learning (ML) (AI/ML or AIML) positioning model, to calculate a location of a wireless device using wireless signals. In some examples, a user equipment (UE) may receive a Wi-Fi positioning configuration including a set of measurement gaps for a reception of a set of Wi-Fi reference signals (RSs). The UE may receive the set of Wi-Fi RSs during the set of measurement gaps. The UE may measure the set of Wi-Fi RSs. The UE may calculate a position of the UE using a positioning model based on the measured set of Wi-Fi RSs. The UE may transmit a report message including the calculated position of the UE. In some aspects, the UE may receive a UE-to-universal mobile telecommunications system terrestrial radio access network (UE-UTRAN) (Uu) positioning configuration including a second set of measurement gaps for a second reception of a set of Uu RSs. The UE may receive the set of Uu RSs during the second set of measurement gaps. The UE may measure the set of Uu RSs. The apparatus may calculate the position of the UE using the positioning model further based on the measured set of Uu RSs.

In some examples, a network entity, such as a location management function (LMF) may transmit, for a UE, a Wi-Fi positioning configuration to calculate a position of the UE based on a set of Wi-Fi RSs. The Wi-Fi positioning configuration may include a set of measurement gaps associated with the set of Wi-Fi RSs. The network entity may receive a report message including a calculated position of the UE based on the set of Wi-Fi RSs. The network entity may transmit a Uu positioning configuration to calculate the position of the UE further based on a set of Uu RSs. The Uu positioning configuration may include a second set of measurement gaps associated with the set of Uu RSs. The calculated position of the UE may be further based on the set of Uu RSs.

Some aspects more specifically relate to UEs configured to calculate its location, or an intermediary measurement that may be used to calculate its location, using wireless signals of a first wireless technology (e.g., Wi-Fi signals) during measurement gaps of a second wireless technology (e.g., Uu signals). The first and second wireless technology may have a different bandwidth, different data packet structure, different waveform, and/or different signal design.

In some aspects, a positioning system may use infrastructure from two types of wireless systems, for example Wi-Fi infrastructure (e.g., Wi-Fi access points (APs)) and new radio (NR) infrastructure (e.g., NR transmission reception points (TRPs)), as anchors to improve positioning using a positioning model. The positioning model may be an artificial intelligence (AI)/machine learning (ML) (AI/ML or AIML) positioning model. In other words, a positioning model may use joint NR and Wi-Fi positioning signal measurements to calculate a position of a UE. In one aspect, a UE may receive a first set of RSs (e.g., a positioning reference signal (PRS), a synchronization signal block (SSB), a channel state information (CSI) reference signal (CSI-RS) sent from a first set of TRPs and may obtain a first set of measurements (e.g., a channel impulse response (CIR), a channel frequency response (CFR), a power delay profile (PDP), a delay profile (DP), a reference signal received power (RSRP), a reference signal received power path (RSRPP), a reference signal time difference (RSTD), or an angle of departure (AoD)). The UE may receive a second set of RSs (e.g., a long-training field (LTF), a short training field (STF), a legacy LTF (L-LTF), a legacy STF (L-STF), a high-efficiency (HE) LTF (HE-LTF), a null data packet (NDP)) sent from a second set of Wi-Fi devices (e.g., Wi-Fi APs) and may obtain a second set of measurements (e.g., a CIR, a CFR, a power delay profile (PDP), a delay profile (DP), a reference signal strength indicator (RSSI), a round-trip time (RTT)) by measuring at least some of the second set of RSs. The UE may input the first and second sets of measurements into positioning model (e.g., an AI/ML positioning model) to estimate the UE location. The UE may report the UE location to a network entity (e.g., LMF) along with an indication that both Uu and Wi-Fi signals have been used for positioning and/or an indication of the Wi-Fi/Uu devices used for positioning (e.g., Wi-Fi AP IDs, TRP IDs). In some aspects, the UE may receive a third set of reference signals sent from the second set of Wi-Fi devices and may obtain a third set of measurements. The UE may input the third set of measurements into a positioning model to estimate UE location. The UE may report the UE location to a network entity (e.g., LMF) along with an indication that Wi-Fi signals, and no other types of wireless signals, have been used for positioning and/or an indication of the Wi-Fi devices used for positioning. In some aspects, a UE may indicate its capabilities for using a positioning model to calculate its position based on different types of wireless signals (e.g., Uu RSs and Wi-Fi RSs) to a network entity and may receive assistance data (AD) from the network entity on how to conduct such positioning.

Particular aspects of the subject matter described in this disclosure can be implemented to realize one or more of the following potential advantages. In some examples, by enabling a UE to calculate its position based on Wi-Fi RSs and/or Uu RSs instead of based on Uu RSs without any other types of wireless signals, the described techniques can be used to improve positioning by leveraging the ubiquity of Wi-Fi APs and Wi-Fi stations (STAs) in environments where UEs are in use, for example homes, hotels, hospitals, offices, campuses, shopping malls, and/or playgrounds. Such environments may have structures or other wireless devices which may reduce the accuracy of positioning based on Uu signals alone, so leveraging Wi-Fi devices to improve the accuracy may mitigate such interference.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

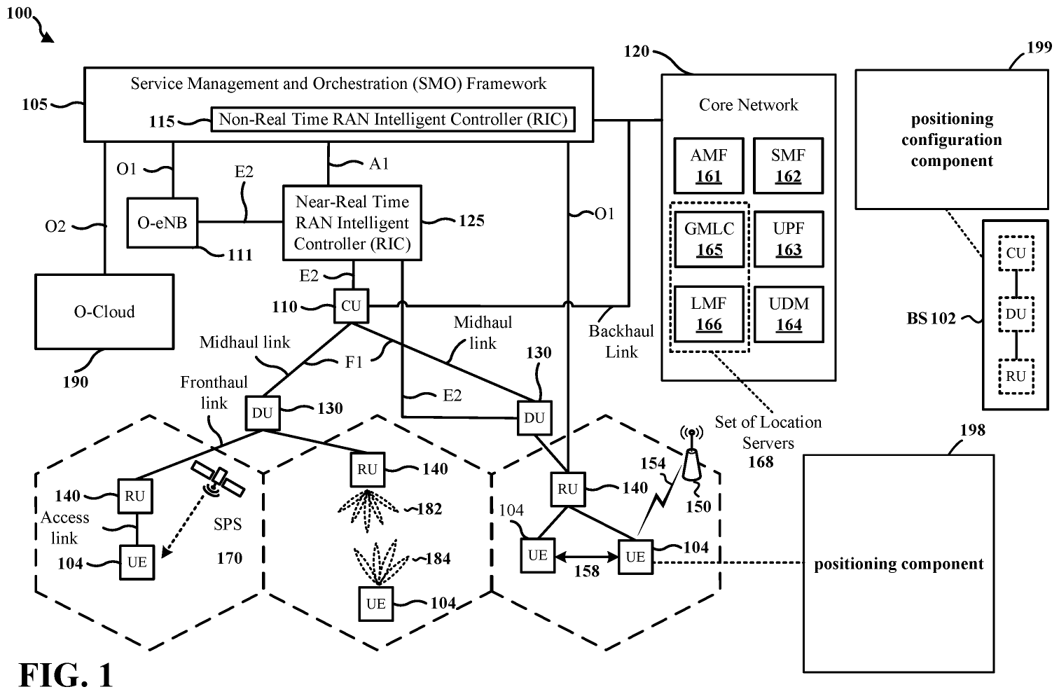

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a positioning component 198 that may be configured to receive a Wi-Fi positioning configuration including a set of measurement gaps for a reception of a set of Wi-Fi RSs. The positioning component 198 may be configured to receive the set of Wi-Fi RSs during the set of measurement gaps. The positioning component 198 may be configured to measure the set of Wi-Fi RSs. The positioning component 198 may be configured to calculate a position of the UE 104 using a positioning model based on the measured set of Wi-Fi RSs. The positioning component 198 may be configured to transmit a report message including the calculated position of the UE 104. The positioning component 198 may be configured to receive a Uu positioning configuration including a second set of measurement gaps for a second reception of a set of Uu RSs. The positioning component 198 may be configured to receive the set of Uu RSs during the second set of measurement gaps. The positioning component 198 may be configured to measure the set of Uu RSs. The positioning component 198 may be configured to calculate the position of the UE 104 using the positioning model further based on the measured set of Uu RSs. In certain aspects, the base station 102 (e.g., the core network 120, the one or more location servers 168, the LMF 166) may have a positioning configuration component 199 that may be configured to transmit, for the UE 104, a Wi-Fi positioning configuration to calculate a position of the UE 104 based on a set of Wi-Fi RSs. The Wi-Fi positioning configuration may include a set of measurement gaps associated with the set of Wi-Fi RSs. The positioning configuration component 199 may be configured to receive a report message including a calculated position of the UE 104 based on the set of Wi-Fi RSs. The positioning configuration component 199 may be configured to transmit a Uu positioning configuration to calculate the position of the UE 104 further based on a set of Uu RSs. The Uu positioning configuration may include a second set of measurement gaps associated with the set of Uu RSs. The calculated position of the UE 104 may be further based on the set of Uu RSs.

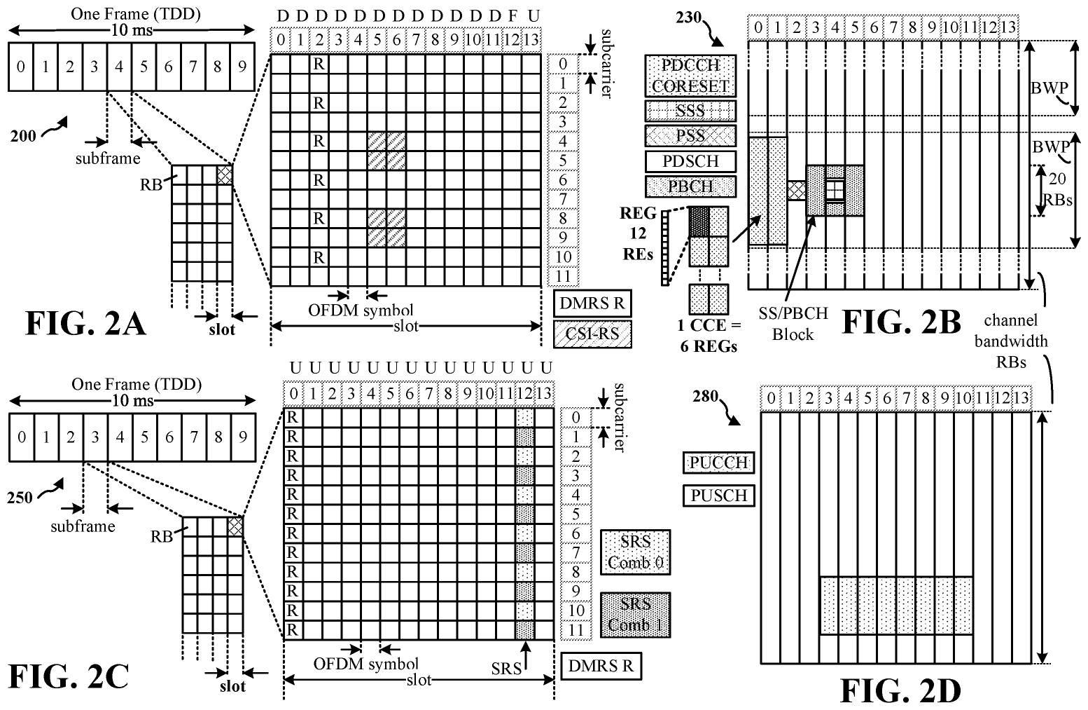

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

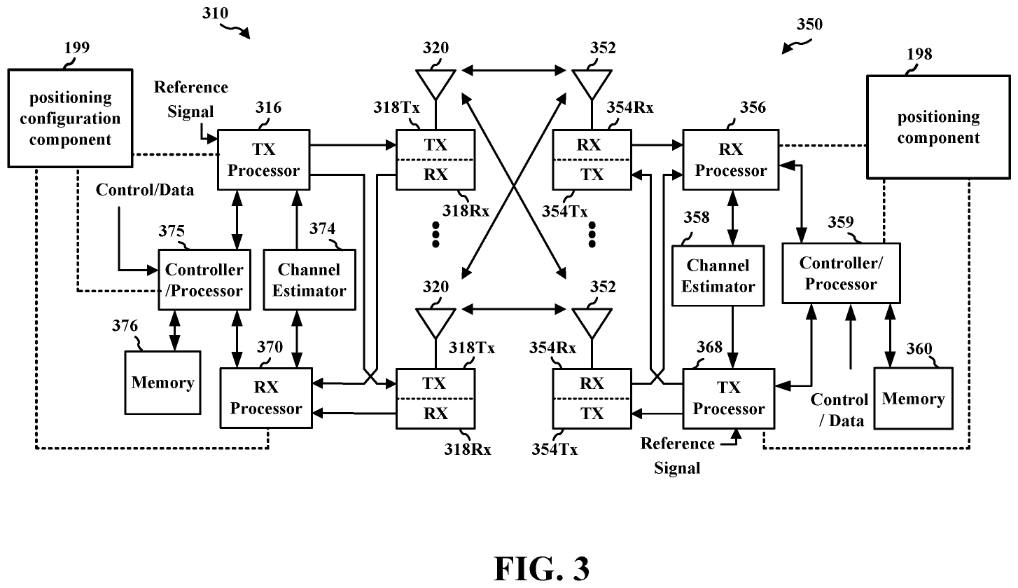

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning component 198 of FIG. 1.

At least one of the TX processor 316, the RX processor 370, and the controller/processor 375 may be configured to perform aspects in connection with the positioning configuration component 199 of FIG. 1.

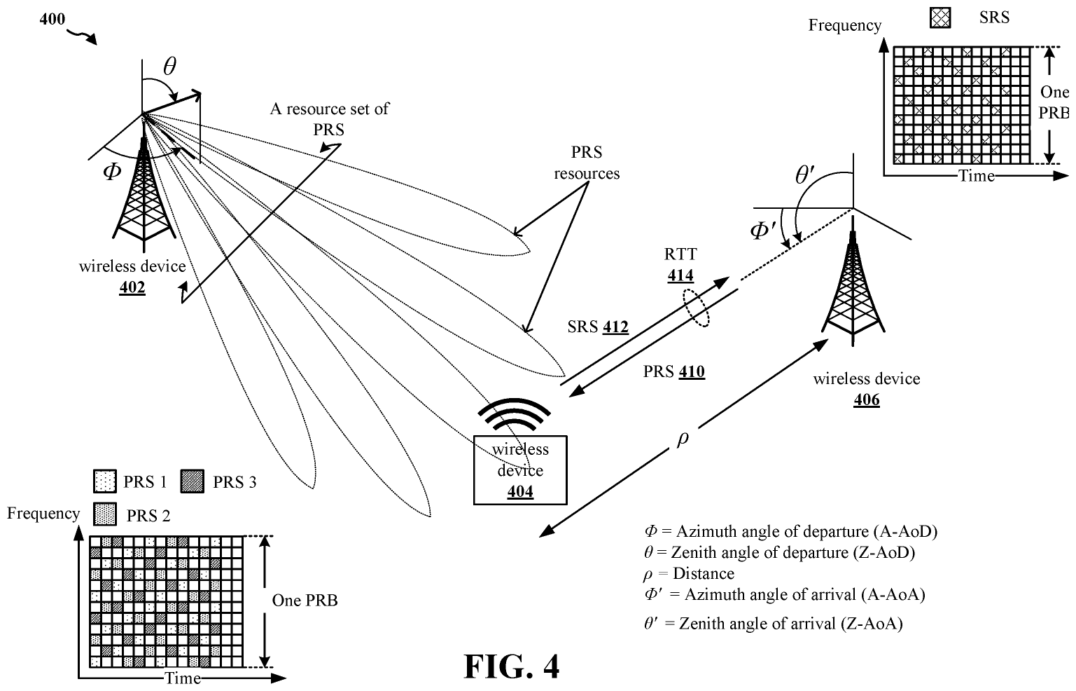

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time T_{SRS_TX} and receive DL positioning reference signals (PRS) (DL-PRS) 410 at time T_{PRS_RX}. The wireless device 406 may receive the UL-SRS 412 at time T_{SRS_RX} and transmit the DL-PRS 410 at time T_{PRS_TX}. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}-T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. In some aspects, the wireless device 404 may initiate an RTT transmission, measuring the return time by measuring the time to receive the DL-PRS 410. In some aspects, the wireless device 406 may initiate an RTT transmission, measuring the return time by measuring the time to receive the UL-SRS 412. In such aspects, the wireless device 406 may transmit the measurement to the wireless device 404 for use in calculation a position/location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

While a wireless device may perform positioning with base stations via Uu signals, since Wi-Fi APs and STAs have good availability in certain indoor and close-to-indoor areas (e.g., homes, hotels, hospitals, offices, campuses, shopping malls, playgrounds), a wireless device may improve positioning by leveraging such ubiquitous Wi-Fi devices for enhancing its positioning. In some aspects, a positioning model, such as an AI/ML positioning model, may be used to learn how to best leverage Wi-Fi signals to perform positioning, or to fuse features via both Uu signals and Wi-Fi signals. In some aspects, Wi-Fi APs may be used as extra anchors in addition to Uu base stations. A wireless device that has hardware capable of transmitting/receiving two different types of wireless technologies, such as Uu signals and Wi-Fi signals, may be configured to coordinate measurements of both types of signals and leverage the measurements for improved positioning.

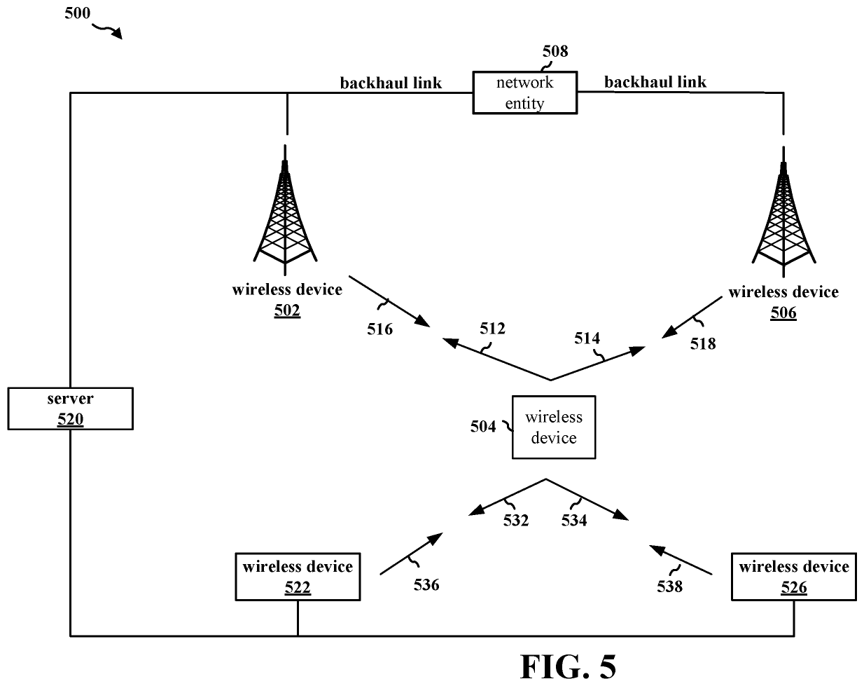

FIG. 5 is a diagram 500 illustrating a network entity 508 that may be configured to coordinate a wireless device 502, a wireless device 506, a wireless device 522, and a wireless device 526 to perform positioning with a wireless device 504. The position/location of the wireless device 502, the wireless device 506, the wireless device 522, and the wireless device 526 may be known to at least one device, such as the wireless device 502, the wireless device 504, the wireless device 506, the wireless device 522, the wireless device 526, the server 520 and/or the network entity 508. The wireless device 502 may be a base station, a gNB, or a TRP. A location of a wireless device may include where the wireless device is located (e.g., GPS coordinates including latitude, longitude, and/or elevation). A position of a wireless device may include where the wireless device is located plus an orientation of a set of antennas (i.e., panels) at the wireless device. A positioning device is configured to assist in providing measurements to calculate at least a location of a wireless device. A subset of positioning devices may be configured to assist in providing measurements to calculate a position of a wireless device (e.g., configured to provide beam forming measurements). The wireless device 506 may be a base station, a gNB, or a TRP. The wireless device 504 may be a UE or a PRU. A PRU may be a UE with a known position/location, for example the PRU may be affixed in place or may be placed in a known position/location for a period of time, or the PRU may have a set of sensors (e.g., high-accuracy GNSS sensor) that may be used to accurately calculate the location of the PRU. The network entity 508 may be connected to the wireless device 502 and the wireless device 506 via a physical link, for example a backhaul link or a midhaul link, or via a wireless link, such as an air interface (Uu) link. The network entity 508 may be part of a core network, such as an LMF or a set of location servers. The wireless device 522 may be a Wi-Fi AP or a Wi-Fi STA. The wireless device 526 may be a Wi-Fi AP or a Wi-Fi STA. The server 520 may control or communicate with the wireless device 522 and/or the wireless device 526 via a wired or a wireless connection. For example, the server 520 may control a set of Wi-Fi APs in a building. The network entity 508 may communicate with the server 520 via a wired or wireless network connection, for example the Internet. In some aspects, the server 520 may be a component of the network entity 508, for example a core network. The network entity 508 may configure positioning occasions between the wireless device 502, the wireless device 504, the wireless device 506, the wireless device 522, and the wireless device 526. In some aspects, the server 520 may transmit configurations for the wireless device 522 and/or the wireless device 526 to the network entity 508 via a dedicated link. In some aspects, the network entity 508 may transmit configurations for the wireless device 522 and/or the wireless device 526 to the server 520 for distribution to the wireless device 522 and/or the wireless device 526. For example, the network entity 508 may be an LMF, and the wireless device 522 may be a Wi-Fi AP, and the server 520 may transmit configurations about an existing Wi-Fi AP to the LMF through a dedicated link with Wi-Fi infrastructure. The server 520 may be a non-3GPP entity, for example a server on the Internet or on an intranet. The network entity 508 may establish a proprietary link/interface with the server 520, which may be a managing entity of the wireless device 522 and/or the wireless device 526. The managing entity may be, for example, an information technology (IT) department for an organization (e.g., a campus, an office, a mall, a hospital, a factory) which may control Wi-Fi infrastructure for a zone about the wireless device 504.

The wireless device 502 and the wireless device 506 may be configured to transmit and/or receive wireless signals of a first type, while the wireless device 522 and the wireless device 526 may be configured to transmit and/or receive wireless signals of a second type. For example, the wireless device 502 and the wireless device 506 may be configured to transmit and/or receive Uu signals (e.g., PRS, SRS, CSI-RS, SSB) and the wireless device 522 and the wireless device 526 may be configured to transmit and/or receive Wi-Fi signals (e.g., NDP, LTF, STF, L-LTF, L-STF, HE-LTF). In other words, a Wi-Fi positioning signal may be a preamble of a Wi-Fi transmission, or may be a Wi-Fi transmission with an NDP. An NDP may be an NDP announcement (NDPA). The wireless device 504 may have one or more transmitters configured to transmit and/or receive signals via both types. For example, the wireless device 504 may have a set of antennas functionally coupled to a Uu transceiver and a Wi-Fi transceiver, or the wireless device 504 may have a first set of antennas functionally coupled to a Uu transceiver and a second set of antennas functionally coupled to a Wi-Fi transceiver.

To perform positioning, the network entity 508 may configure the wireless devices to transmit positioning signals at one another. For example, the wireless device 504 may transmit the set of positioning signals 512 at the wireless device 502. The set of positioning signals 512 may be a set of SRSs, SSBs, or CSI-RSs. The wireless device 502 may measure the set of positioning signals 512. The wireless device 502 may transmit the set of positioning signals 516 at the wireless device 504. The set of positioning signals 516 may be a set of PRSs, SSBs, or CSI-RSs. The wireless device 504 may measure the set of positioning signals 516. The wireless device 504 may transmit a set of positioning signals 514 at the wireless device 506. The set of positioning signals 514 may be a set of SRSs, SSBs, or CSI-RSs. The wireless device 506 may measure the set of positioning signals 514. The wireless device 506 may transmit a set of positioning signals 518 at the wireless device 504. The set of positioning signals 518 may be a set of PRSs, SSBs, or CSI-RSs. The wireless device 504 may measure the set of positioning signals 518. The wireless device 504 may transmit a set of positioning signals 532 at the wireless device 522. The set of positioning signals 532 may be a set of NDPs, LTFs, STFs, L-LTFs, L-STFs, or HE-LTFs. The wireless device 522 may measure the set of positioning signals 532. The wireless device 522 may transmit a set of positioning signals 536 at the wireless device 504. The set of positioning signals 536 may be a set of NDPs, LTFs, STFs, L-LTFs, L-STFs, or HE-LTFs. The wireless device 504 may measure the set of positioning signals 536. The wireless device 504 may transmit a set of positioning signals 534 at the wireless device 526. The set of positioning signals 534 may be a set of NDPs, LTFs, STFs, L-LTFs, L-STFs, or HE-LTFs. The wireless device 526 may measure the set of positioning signals 534. The wireless device 526 may transmit a set of positioning signals 538 at the wireless device 504. The set of positioning signals 538 may be a set of NDPs, LTFs, STFs, L-LTFs, L-STFs, or HE-LTFs. The wireless device 504 may measure the set of positioning signals 538.

One or more of the wireless devices may measure the received positioning signals to calculate a positioning measurement that may be used to calculate a location of the wireless device 504, or may be used to calculate a position or a location of the wireless device 504. For example, if the location of the wireless device 502 and the location of the wireless device 506 are known, the location of the wireless device 504, or a location attribute that may be used to calculate the location of the wireless device 504, may be calculated based on a CIR, CFR, PDP. DP. RSRP. RSRPP. RSTD, AOD, and/or RTT between the wireless device 502 and the wireless device 504, and a CIR, CFR. PDP, DP, RSRP, RSRPP, RSTD, AoD, and/or RTT between the wireless device 504 and the wireless device 506. If the location of the wireless device 522 and the location of the wireless device 526 are known, the location of the wireless device 504, or a location attribute that may be used to calculate the location of the wireless device 504, may be calculated based on a CIR, CFR, PDP, DP. RSSI, and/or RTT between the wireless device 522 and the wireless device 504, and a CIR, CFR, PDP, DP, RSSI, and/or RTT between the wireless device 504 and the wireless device 526. A measurement of a positioning signal may also be referred to as a radio frequency fingerprint (RFFP). A measurement of a Uu signal may be referred to as a Uu RFFP and a measurement of a Wi-Fi signal may be referred to as a Wi-Fi RFFP. A positioning model configured to calculate a position/location of a wireless device based on measurements of Wi-Fi signals may be referred to as a positioning model that uses Wi-Fi RFFPs to calculate outputs. A positioning model configured to calculate a position/location of a wireless device based on measurements of Wi-Fi signals and Uu signals may be referred to as a positioning model that uses Wi-Fi RFFPs and Uu RFFPs to calculate outputs. A Wi-Fi RFFP may be calculated based on measuring a Wi-Fi preamble (e.g., LTF), and a Uu RFFP may be calculated based on measuring a Uu RS (e.g., PRS). RFFPs may be transmitted and/or aggregated on any device with a positioning model, for example the wireless device 502, the wireless device 504, the wireless device 506, the wireless device 522, the wireless device 526, the network entity 508, the server 520, or an OTT server. Any reference signal in a Wi-Fi preamble may be measured to derive a Wi-Fi RFFP.

In some aspects, the wireless device 504 may perform a fine timing measurement (FTM) procedure to measure an RTT between the wireless device 504 and an AP/STA (e.g., the wireless device 522 and/or the wireless device 526). If the wireless device 504 performs the FTM procedure with multiple peer STAs/UEs, the wireless device 504 may measure changes in its relative position with those peer STAs/UEs. The absolute position of the peer STAs/UEs may be input into an algorithm, or a positioning model, to allow the wireless device 504 to calculate its position/location relative to the peer STAs/UEs. In some aspects, the wireless device 504 may calculate the direction of a transmission (i.e., AoD) of frames transmitted to a peer STA/UE, and/or calculate the direction of a reception (i.e., AoA) of frames transmitted from a peer STA/UE. This allows a positioning algorithm, or a positioning model, to better calculate the position/location of the wireless device 504 based on the measurements.

In some aspects, the wireless device 504 may perform positioning based on ranging packets with APs having known static locations, or STAs/UEs having calculated locations. For example, the wireless device may perform FTM with enhanced distributed channel access. The wireless device 504 may perform trigger-based (TB) ranging, non-trigger-based (non-TB) ranging, and/or passive TB ranging. The wireless device 504 may negotiate an FTM session to determine range estimates by executing an EDCA-based exchange of FTM frames, a TB measurement, a non-TB measurement, and/or a passive TB ranging measurement. The wireless device 504 may conduct an EDCA-based exchange of FTM frames where measurements are based on time of departure (ToD) and time of arrival (ToA) of the exchanged FTM frames and their corresponding acknowledgements. After the negotiated FTM session, the wireless device 504 may negotiate enhanced directional multi-Gigabit (EDMG) parameters and/or security parameters to facilitate a measurement exchange with an intended device. The wireless device 504 may measure a TB measurement based on an execution of a TB measurement exchange. The wireless device 504 may allow for the execution of a measurement exchange between a responding AP/STA and one or more initiating APs/STAs at the same time. In some aspects, the wireless device 504 may negotiate a TB measurement session to enable security parameter enabling mechanism to ensure that the measurement exchange is executed with an intended device. The wireless device 504 may measure a non-TB measurement based on an execution of a non-TB measurement exchange. In some aspects, the wireless device 504 may negotiate a non-TB measurement session to enable security parameter enabling mechanisms such that a measurement exchange is executed with an intended device. The wireless device 504 may conduct a passive TB ranging measurement exchange where an AP/STA may calculate its location based on periodic measurement reports from other APs/STAs that execute the passive TB ranging measurement exchange amongst themselves.

In some aspects, the network entity 508 may configure measurement gaps and/or processing gaps for a wireless device to measure a positioning signal. The network entity 508 may transmit a Uu signal configuring a measurement gap and/or a processing gap to measure a Wi-Fi signal. In other words, the network entity 508 may transmit a Uu signal that configures a measurement gap and/or a processing gap for the wireless device 502, the wireless device 504, and/or the wireless device 506 to measure Uu positioning signals. The network entity 508 may transmit a Uu signal that configures a measurement gap and/or a processing gap for the wireless device 504, the wireless device 522, and/or the wireless device 526 to measure Wi-Fi positioning signals. In some aspects, the configuration for measuring Wi-Fi positioning signals may include an indicator of a set of Wi-Fi anchors that the wireless device 504 may select to measure Wi-Fi positioning signals. The network entity 508 may transmit AD for WLAN positioning that includes an indicator of a set of Wi-Fi anchors. The wireless device 504 may select Wi-Fi positioning signals to measure based on the set of Wi-Fi anchors, or may prioritize a selection of Wi-Fi positioning signals to measure based on the set of Wi-Fi anchors indicated by the network entity 508.

In some aspects, a positioning model may be used to calculate one or more positioning metrics based on the measurements. For example, based on the measurements of the set of positioning signals 512, the set of positioning signals 514, the set of positioning signals 532, and/or the set of positioning signals 534 transmitted by the wireless device 504, a position of the wireless device 504 may be calculated or estimated, or an intermediate measurement that may be used to calculate the location of the wireless device 504 may be calculated or estimated. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, a CSI-RS, an NDP, an LTF, an STF, an L-LTF, an L-STFs, or an HE-LTF. An RS transmitted from a UE, such as a PRU, may be referred to as an uplink positioning signal, or an UL positioning signal. A measurement may be a CIR, CFR, PDP, DP, RSRP. RSRPP. RSTD, AOD, RSSI, RTT, or other measurement used for performing positioning on a target wireless device. A label may be a calculated, derived, or given (i.e., known) expected result associated with a set of inputs, such as a location of the wireless device 504 or an intermediate measurement (e.g., a timing measurement, an angle measurement, a LOS identification) that may be used to calculate the location of the wireless device 504. A set of inputs and a set of labels may be used for generating and/or training a positioning model using AI/ML. The positioning model may be configured to calculate a position/location of the wireless device 504 based on a set of Wi-Fi RFFP (e.g., HE-LTF-based CIR). The positioning model may be configured to calculate a position/location of the wireless device 504 based on a set of Wi-Fi RFFP and a set of Uu RFFP (e.g., PRS-based CIR).

In some aspects, the wireless device 504 may obtain the positioning model by training the positioning model at the wireless device 504, by obtaining the positioning model from a vendor (e.g., a UE vendor), or by obtaining the positioning model via an implementation (e.g., a UE implementation). In some aspects, the wireless device 504 may receive the positioning model from a training entity, or a network/over-the-top (OTT) server device that stores a positioning model. For example, the network entity 508 may transmit the positioning model to the wireless device 504. The positioning model may be configured to calculate a position/location of the wireless device 504 (or an intermediate measurement that may be used to calculate a position/location of the wireless device 504) using a first wireless technology (e.g., Wi-Fi signals), where the measurements of the positioning signals of the first wireless technology are collected during measurement gaps of a second wireless technology (e.g., Uu signals). The positioning model may be configured to calculate a position/location of the wireless device 504 (or an intermediate measurement that may be used to calculate a position/location of the wireless device 504) using a first wireless technology (e.g., Wi-Fi signals) and a second wireless technology (e.g., Uu signals), where the measurements of the positioning signals of the first wireless technology are collected during measurement gaps of a second wireless technology (e.g., Uu signals). The wireless device may have at least two transceivers such that a first transceiver is used for the first wireless technology and a second transceiver is used for the second wireless technology. The wireless device 504 may have at least two transceivers and at least two antennas such that one set of transceiver/antenna is used for the first wireless technology and the other set of transceiver/antenna is used for the second wireless technology.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 504 may have a positioning model configured to set a set of positioning measurements and generate an estimate of a location of the wireless device 504. In another example, the wireless device 504 may have a positioning model configured to accept a set of positioning measurements and generate an intermediate measurement (e.g., a timing measurement, an angle measurement, a LOS identification) that may be used (by the wireless device 504, or another entity, such as the network entity 508, the wireless device 502, the wireless device 506, the wireless device 522, the wireless device 526, or the server 520) to calculate the location of the wireless device 504. In another example, the wireless device 502 may have a positioning model configured to accept a set of positioning measurements and generate an estimate of a location of the wireless device 504. In another example, the wireless device 502 may have a positioning model configured to accept a set of positioning measurements and generate an intermediate measurement (e.g., a timing measurement, an angle measurement, a LOS identification) that may be used (by the wireless device 502, or another entity, such as the network entity 508, the wireless device 504, the wireless device 506, the wireless device 522, the wireless device 526, or the server 520) to calculate the location of the wireless device 504. In another example, the wireless device 506 may have a positioning model configured to accept a set of positioning measurements and generate an intermediate measurement (e.g., a timing measurement, an angle measurement, a LOS identification) that may be used (by the wireless device 506, or another entity, such as the network entity 508, the wireless device 504, the wireless device 502, the wireless device 522, the wireless device 526, or the server 520) to calculate the location of the wireless device 504. In another example, the network entity 508 may have a positioning model configured to accept a set of positioning measurements and generate an estimate of a location of the wireless device 504. In some aspects, the positioning measurements may be aggregated by the entity with the positioning model, for example, the wireless device 504 may aggregate measurements of the set of positioning signals 516, the set of positioning signals 518, the set of positioning signals 536, and/or the set of positioning signals 538. In some aspects, the network entity 508 may aggregate measurements of the set of positioning signals 512 from the wireless device 502, measurements of the set of positioning signals 514 the wireless device 506 to use as inputs to a positioning model.

A positioning model may be trained on a wireless device that performs positioning, such as the wireless device 502, the wireless device 504, the wireless device 506, the wireless device 522, the wireless device 526, and/or the network entity 508, or may be trained on an offline device, such as an over-the-top (OTT) server. The inputs to the positioning model may include measurements of positioning signals, such as measurements of SRS, PRS, SSB, CSI-RS, NDP, LTF, STF, L-LTF, L-STF, and/or HE-LTF. The inputs to the measurements may include assistance information associated with the measured positioning signals, such as BWP of a positioning signal resource, number of TRPs, beam information, positioning signal configuration, identifiers of TRPs, identifiers of Wi-Fi APs). The labels/outputs for the positioning model may include a location, or an intermediate measurement.

In some aspects, a positioning model may be configured to use measurements of positioning signals transmitted to the wireless device 504 to calculate a position of the wireless device 504, or to calculate an intermediate measurement that may be used to calculate the position of the wireless device 504. The positioning model may be trained via a training entity, and may be used at the wireless device 504, at the wireless device 502, at the wireless device 506, at the wireless device 522, at the wireless device 526, at the server 520, or at the network entity 508. For example, a positioning model at the wireless device 504 may be configured to calculate the location of the wireless device 504 based on measurements of the set of positioning signals 516, the set of positioning signals 518, the set of positioning signals 536, and/or the set of positioning signals 538. In another example, a positioning model at the wireless device 504 may be configured to calculate a set of intermediate measurements based on measurements of the set of positioning signals 516, the set of positioning signals 518, the set of positioning signals 536, and/or the set of positioning signals 538. The wireless device 504 may transmit the set of intermediate measurements to the network entity 508 so that the network entity 508 may calculate the location of the wireless device 504 based on the set of intermediate measurements. In another example, the wireless device 504 may transmit measurements of the set of positioning signals 516, the set of positioning signals 518, the set of positioning signals 536, and/or the set of positioning signals 538 to the network entity 508. The positioning model may be at the network entity 508. The positioning model at the network entity 508 may calculate the location of the wireless device 504 based on the transmitted measurements of the set of positioning signals 516, the set of positioning signals 518, the set of positioning signals 536, and/or the set of positioning signals 538 from the wireless device 504.

Measurements of positioning signals may be performed by measuring channels between a target device (e.g., the wireless device 504) and a set of network nodes (e.g., the wireless device 502, the wireless device 506, the wireless device 522, and/or the wireless device 526).

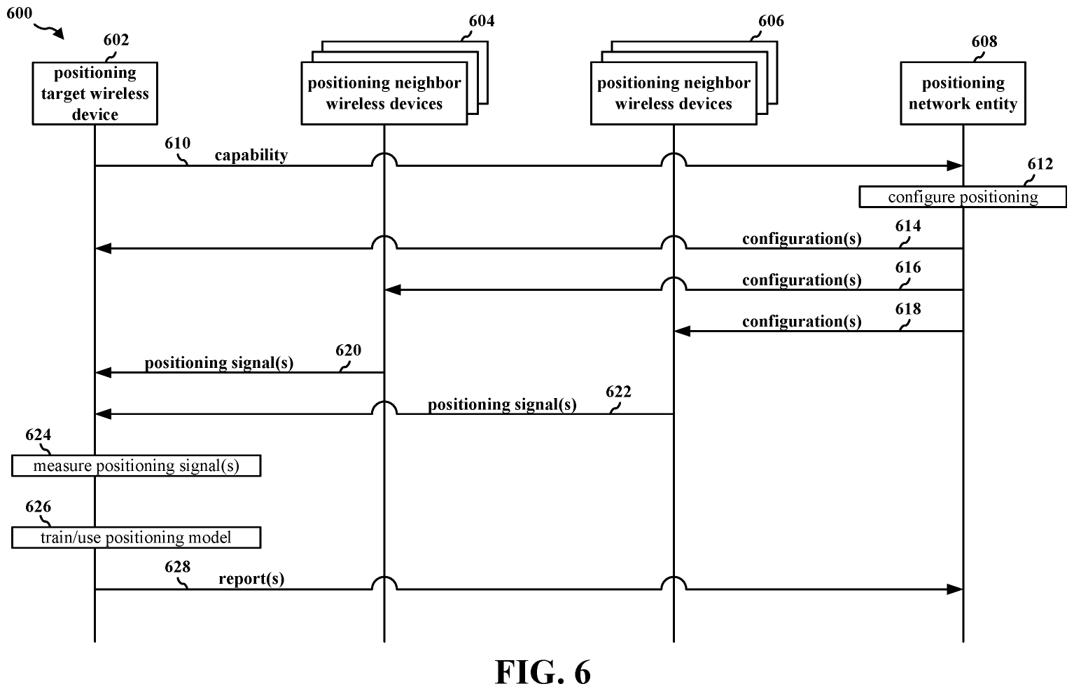

FIG. 6 is a connection flow diagram 600 illustrating an example of a positioning target wireless device 602 configured to utilize a positioning model with different types of wireless positioning signals, for example the set of positioning signals 620 from the set of positioning neighbor wireless devices 604 and/or the set of positioning signals 622 from the set of positioning neighbor wireless devices 606. The set of positioning signals 620 and the set of positioning signals 622 may be different types of positioning signals, for example Wi-Fi positioning signals and Uu positioning signals. The positioning target wireless device 602 may be a UE or a PRU. A PRU may be used to train a positioning model, and a UE may be used to use a positioning model to calculate the position of the positioning target wireless device 602, or to calculate an intermediate measurement that may be used to calculate the position of the positioning target wireless device 602. The set of positioning neighbor wireless devices 604 may be a set of wireless devices configured to transmit a type of positioning signal, for example Wi-Fi positioning signals (e.g., NDP, LTF, STF, L-LTF, L-STF, HE-LTF). The set of positioning neighbor wireless devices 604 may include a set of Wi-Fi APs and/or a set of Wi-Fi STAs. The set of positioning neighbor wireless devices 606 may be a set of wireless devices configured to transmit a type of positioning signal different than the set of positioning signals 620, for example Uu positioning signals (e.g., PRS, SRS. CSI-RS. SSB). The set of positioning neighbor wireless devices 606 may include a set of TRPs, a set of network nodes, or a set of UEs. The positioning network entity 608 may be a device that configures positioning for the positioning target wireless device 602, for example a core network, an LMF, and/or a server.

The positioning target wireless device 602 may transmit a capability 610 to the positioning network entity 608. The positioning network entity 608 may receive the capability 610 from the positioning target wireless device 602. The capability 610 may include an indication of a capability of the positioning target wireless device 602 to perform positioning based on at least one of a type of wireless signal (e.g., capability to perform positioning based on a set of Wi-Fi positioning signals, capability to perform positioning based on a set of Uu positioning signals, capability to perform positioning based on both a set of Wi-Fi positioning signals and a set of Uu positioning signals). The capability 610 may include at least one of an indicator of a supported Wi-Fi bandwidth (e.g., supported frequency bands, supported channels), an indicator of a supported Uu bandwidth (e.g., supported frequency bands, supported channels), an indicator of a set of supported Wi-Fi resources (e.g., number of resources, number of Wi-Fi APs, number of preambles, support for multi-stream Wi-Fi ranging), an indicator of a set of supported Uu resources (e.g., number of PRS resources, number of SRS resources), an indicator of a set of supported Wi-Fi measurement gaps, an indicator of a set of supported Uu measurement gaps, an indicator of whether the positioning target wireless device 602 can perform positioning on Wi-Fi and/or Uu positioning signals sequentially or concurrently, an indicator of a set of supported ranging modes (e.g., legacy, enhanced distributed channel access (EDCA), non-trigger based transport block (TB) ranging, TB ranging, passive TB ranging, multi-stream ranging, MIMO ranging), an indicator of a set of supported preamble signals (e.g., L-STF, L-LTF, HE-LTF), an indicator of a set of supported APs/STAs (e.g., system identifiers (SIDs) that the positioning target wireless device 602 detects), an indicator of a supported positioning model mode (e.g., Wi-Fi positioning, Uu positioning, Uu & Wi-Fi positioning, NR & Wi-Fi positioning. NR. LTE, & Wi-Fi positioning), an indicator of a supported positioning measurement (e.g., CIR, CFR, PDP, DP, RSRP, RSRPP, RSTD, AOD, PDP, DP, RSSI, RTT), an indicator of a supported reporting trigger (e.g., periodic, event-based, based on Wi-Fi availability), an indicator of what kinds of positioning signals the positioning target wireless device 602 is able to measure, an indicator of what kinds of assistance data (AD) the positioning target wireless device 602 may use to collect RFFP measurements, an indicator of types of positioning modes that the positioning target wireless device 602 supports, an indicator of types of positioning report modes (e.g., periodic reporting) that the positioning target wireless device 602 supports, an indicator of whether the positioning target wireless device 602 measures Uu signals, or Wi-Fi signals, during an idle state, and/or an indicator of whether the positioning target wireless device 602 supports scheduled location requests.

The capability 610 may include an indicator of a bandwidth capability of Uu signals along with supported frequency bands and channels. The capability 610 may include an indicator of a bandwidth capability of Wi-Fi signals along with supported frequency bands and channels. The capability 610 may include an indicator of a resource capability of Uu signals and/or Wi-Fi signals. The resource capability may include a maximum number of positioning signal resources, a maximum number of TRPs/APs to measure/report, a maximum number of Wi-Fi preambles to measure, and/or whether the positioning target wireless device 602 is able to support multi-stream Wi-Fi ranging. The capability 610 may include an indicator of requested processing gaps and/or measurement gaps to handle positioning with Uu signals, Wi-Fi signals, and/or both Uu and Wi-F-signals. The capability 610 may include an indicator of whether the positioning target wireless device 602 is able to collect positioning measurements with two different types of signals sequentially or concurrently. The capability 610 may include an indicator of supported Wi-Fi ranging modes (e.g., legacy, EDCA channel access, non-TB ranging. TB ranging, passive TB ranging). The capability 610 may include an indicator of whether the positioning target wireless device 602 is able to support multi-stream ranging (i.e., MIMO) for a supported Wi-Fi ranging mode. The capability 610 may include an indicator of which Wi-Fi preambles/signals (e.g., NDP, LTF, STF, L-LTF, L-STF, HE-LTF) the positioning target wireless device 602 is able to measure. The capability 610 may include an indicator of which standards (IEEE 802.11a/n/ac/ax/be/ad/ay/az) are associated with the Wi-Fi preambles/signals the positioning target wireless device 602 is able to measure. The capability 610 may include an indicator of Wi-Fi APs/STAs that the positioning target wireless device 602 has detected. The capability 610 may include an indicator of positioning model types (e.g., positioning based on Wi-Fi RFFPs and not Uu RFFPs, positioning based on Uu RFFPs and not Wi-Fi RFFPs, positioning based on both Uu RFFPs and Wi-Fi RFFPs, output of calculated position/location, output of intermediate measurement). The capability 610 may include an indicator of a location of a positioning model (e.g., whether the positioning model is at the positioning target wireless device 602, at a base station, at a network entity, or at an OTT server). The capability 610 may include an indicator of types of measurements (e.g., CIR, CFR, PDP, DP, RSRP, RSRPP. RSTD, AoA, AOD, RTT, multi-RTT, RSSI) the positioning target wireless device 602 is capable of reporting. The capability 610 may include an indicator of how the positioning target wireless device 602 may report the set of reports 628 (e.g., periodic, event-based, trigger-based, scheduled).

The positioning target wireless device 602 may transmit the capability 610 as part of a capability exchange procedure in an LTE positioning protocol (LPP) (LPP) procedure. In other words, the capability 610 may include an LPP message, or other capability message.

At 612, the positioning network entity 608 may configure positioning between the positioning target wireless device 602 and at least some of the set of positioning neighbor wireless devices 604 and/or at least some of the set of positioning neighbor wireless devices 606 based on the capability 610. The positioning network entity 608 may transmit the set of configurations 614 to the positioning target wireless device 602 based on the configuring at 612. In some aspects, the set of configurations 614 may include assistance data, for example WLAN assistance data or NR/LTE assistance data. The set of configurations 614 may include indicators of TRPs and/or APs. The set of configurations 614 may include positioning signal transmission schedules/resources. The set of configurations 614 may include location indicators for the set of TRPs and/or APs. The set of configurations 614 may include an indicator for channels/bands that the positioning target wireless device 602 may use for Wi-Fi/Uu measurements. The set of configurations 614 may include an indicator for positioning signal resource configurations (e.g., PRS resource configuration). The set of configurations 614 may include an indicator for a set of recommended TRPs/APs for the positioning target wireless device 602 to collect measurements based on. The indicator may include TRP ID, service set identifier (SSID), basic service set identifier (BSSID) and/or location information. The set of configurations 614 may include an indicator for a recommended positioning mode (e.g., EDCA channel access ranging, positioning based on data packets, non TB ranging. TB ranging, passive TB ranging, Wi-Fi and not Uu, Uu and not Wi-Fi, both Uu and Wi-Fi) for an algorithm or a positioning model. The set of configurations 614 may include an indicator for processing gaps that the positioning target wireless device 602 may use to process measurements of positioning signals. The set of configurations 614 may include an indicator for measurement gaps that the positioning target wireless device 602 may use to measure positioning signals. The set of configurations 614 may include an indicator for a positioning model that the positioning network entity 608 selects (e.g., where the positioning model may be located, an identifier of the positioning model, how the positioning target wireless device 602 may receive/download the positioning model, access right information). The set of configurations 614 may include an indicator for types of measurements that the positioning target wireless device 602 should collect. The set of configurations 614 may include an indicator for how the positioning target wireless device 602 should report the set of reports 628 (e.g., periodic, event-based, scheduled, maximum number of values to include in each report). The positioning target wireless device 602 may receive the set of configurations 614 from the positioning network entity 608.

The positioning network entity 608 may transmit the set of configurations 616 to the set of positioning neighbor wireless devices 604 based on the configuring at 612. The set of positioning neighbor wireless devices 604 may receive the set of configurations 616 from the positioning network entity 608. The positioning network entity 608 may transmit the set of configurations 616 to the set of positioning neighbor wireless devices 604 via one or more intermediary devices, such as a server that controls a set of Wi-Fi APs/STAs, or the Internet. The positioning network entity 608 may transmit the set of configurations 618 to the set of positioning neighbor wireless devices 606 based on the configuring at 612. The set of positioning neighbor wireless devices 606 may receive the set of configurations 618 from the positioning network entity 608. The positioning network entity 608 may transmit the set of configurations 618 as assistance data to the set of positioning neighbor wireless devices 606. The positioning network entity 608 may transmit the set of configurations 618 as an NR positioning protocol (NRPP) message, for example via an NRPP annex (NRPPa) protocol.

The set of positioning neighbor wireless devices 604 may transmit the set of positioning signals 620 at the positioning target wireless device 602. The set of positioning signals 620 may include a set of NDPs, LTFs, STFs, L-LTFs, L-STFs, and/or HE-LTFs. At 624, the positioning target wireless device 602 may measure the set of positioning signals 620, for example by measuring a CIR, a CFR, a PDP, a DP, an RSSI, and/or an RTT based on the set of positioning signals 620. The positioning target wireless device 602 may measure any portion of the set of positioning signals 620, for example any portion of a preamble (not the payload) or any portion of an NDP.

The set of positioning neighbor wireless devices 606 may transmit the set of positioning signals 622 at the positioning target wireless device 602. The set of positioning signals 622 may include a set of SRSs, PRSs, SSBs, and/or CSI-RSs. At 624, the positioning target wireless device 602 may measure the set of positioning signals 620, for example by measuring a CIR, a CFR, a PDP, a DP, an RSRP, an RSRPP, an RSTD, an AoD, and/or an RTT based on the set of positioning signals 622.

At 626, the positioning target wireless device 602 may train a positioning model (e.g., an AI/MR positioning model) based on the measured positioning signals, for example by inputting a set of measurements and labels into a positioning model. The positioning target wireless device 602 may receive one or more labels in the set of configurations 614 from the positioning network entity 608. In some aspects, the positioning target wireless device 602 may be a PRU with a known location.

At 626, the positioning target wireless device 602 may calculate its position/location, or a measurement that may be used to calculate its position/location, using a positioning model (e.g., an AI/MR positioning model), based on the measured positioning signals, for example by inputting a set of measurements into a positioning model.

The positioning target wireless device 602 may transmit a set of reports 628 to the positioning network entity 608. The positioning network entity 608 may receive the set of reports 628 from the positioning target wireless device 602. The set of reports 628 may include an indicator of the calculated position/location of the positioning target wireless device 602, or an intermediate measurement. The set of reports 628 may include an indicator of what kinds of signals (e.g., Uu signals and not Wi-Fi signals, Wi-Fi signals and not Uu signals, Uu signals and Wi-Fi signals) were used to calculate the output of the positioning model. The set of reports 628 may include an indicator of what devices (e.g., which TRPs, which Wi-Fi APs, which Wi-Fi STAs) were used to calculate the output of the positioning model. In some aspects, the positioning model may be on another device, for example the positioning network entity 608 and/or the positioning target wireless device 602. In such aspects, the set of reports 628 may include a set of measurements and associated indicators (e.g., which TRPs/APs/STAs are associated with each measurement, time stamps, AoA) The positioning target wireless device 602 may transmit an LPP message including the set of reports 628. In some aspects, the positioning target wireless device 602 may report a calculated position/location as part of an LPP protocol (e.g., a 5G NR LPP protocol).

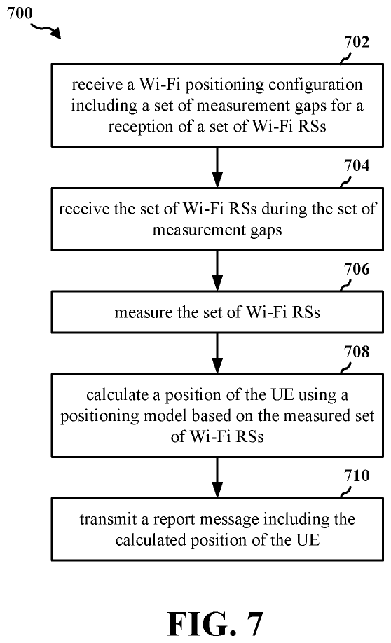

FIG. 7 is a flowchart 700 of a method of wireless communication. The method may be performed by a UE (e.g., the UE 104, the UE 350; the wireless device 404; the wireless device 504; the positioning target wireless device 602; the apparatus 1104). At 702, the UE may receive a Wi-Fi positioning configuration including a set of measurement gaps for a reception of a set of Wi-Fi RSs. For example, 702 may be performed by the positioning target wireless device 602 in FIG. 6, which may receive a set of configurations 614. The set of configurations 614 may include a Wi-Fi positioning configuration including a set of measurement gaps for a reception of the set of positioning signals 620. The set of positioning signals 620 may include a set of Wi-Fi RSs. Moreover, 702 may be performed by the positioning component 198 in FIG. 1, 3, or 11.

At 704, the UE may receive the set of Wi-Fi RSs during the set of measurement gaps. For example, 704 may be performed by the positioning target wireless device 602 in FIG. 6, which may receive the set of positioning signals 620 from the set of positioning neighbor wireless devices 604 during the set of measurement gaps. The set of positioning signals 620 may include the set of Wi-Fi RSs. Moreover, 704 may be performed by the positioning component 198 in FIG. 1, 3, or 11.

At 706, the UE may measure the set of Wi-Fi RSs. For example, 706 may be performed by the positioning target wireless device 602 in FIG. 6, which may, at 624, measure the set of positioning signals 620. The set of positioning signals 620 may include the set of Wi-Fi RSs. Moreover, 706 may be performed by the positioning component 198 in FIG. 1, 3, or 11.

At 708, the UE may calculate a position of the UE using a positioning model based on the measured set of Wi-Fi RSs. For example, 708 may be performed by the positioning target wireless device 602 in FIG. 6, which may, at 626, calculate a position of the positioning target wireless device 602 using a positioning model based on the measured set of Wi-Fi RSs. Moreover, 708 may be performed by the positioning component 198 in FIG. 1, 3, or 11.

At 710, the UE may transmit a report message including the calculated position of the UE. For example, 710 may be performed by the positioning target wireless device 602 in FIG. 6, which may transmit the set of reports 628 to the positioning network entity 608. The set of reports 628 may include a report message including the calculated position of the positioning target wireless device 602. Moreover, 710 may be performed by the positioning component 198 in FIG. 1, 3, or 11.

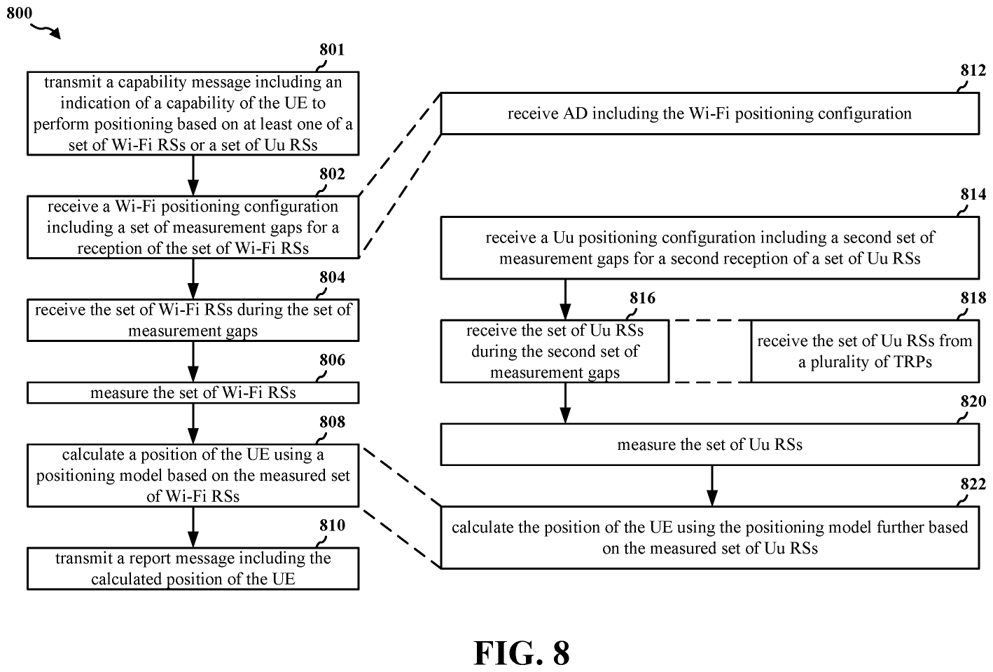

FIG. 8 is a flowchart 800 of a method of wireless communication. The method may be performed by a UE (e.g., the UE 104, the UE 350; the wireless device 404; the wireless device 504; the positioning target wireless device 602; the apparatus 1104).

At 801, the UE may transmit a capability message including an indication of a capability of the UE to perform positioning based on at least one of a set of Wi-Fi RSs or a set of Uu RSs. The transmission of the capability message may be before the reception of the Wi-Fi positioning configuration. The indication of the capability may include at least one of (a) a first indicator of a supported Wi-Fi bandwidth, (b) a second indicator of a supported Uu bandwidth, (c) a third indicator of a set of supported Wi-Fi resources, (d) a fourth indicator of a set of supported Uu resources, (c) a fifth indicator of a set of supported Wi-Fi measurement gaps, (f) a sixth indicator of a set of supported Uu measurement gaps, (g) a seventh indicator of a set of supported ranging modes, (h) an eighth indicator of a set of supported preamble signals, (i) a ninth indicator of a set of supported APs, (j) a tenth indicator of a supported positioning model mode, (k) an eleventh indicator of a supported positioning measurement, or (l) a twelfth indicator of a supported reporting trigger. For example, 801 may be performed by the positioning target wireless device 602 in FIG. 6, which may transmit the capability 610 to the positioning network entity 608. The positioning target wireless device 602 may transmit a capability message, for example an LPP message, including the capability 610. The capability 610 may include an indication of a capability of the positioning target wireless device 602 to perform positioning based on at least one of a set of Wi-Fi RSs or a set of Uu RSs. 801 may be before 802. The Wi-Fi positioning configuration of 802 may be based on the indication of the capability of 801. The indication of the capability may include at least one of (a) an indicator of a Wi-Fi bandwidth that the positioning target wireless device 602 is capable of receiving and measuring, (b) an indicator of a Uu bandwidth that the positioning target wireless device 602 is capable of receiving and measuring. (c) an indicator of a set of Wi-Fi resources that the positioning target wireless device 602 is capable of receiving and measuring. (d) an indicator of a set of Uu resources that the positioning target wireless device 602 is capable of receiving and measuring. (c) an indicator of a set of Wi-Fi measurement gaps (e.g., a minimum length of time for the positioning target wireless device 602 to be able to receive and measure Wi-Fi signals), (f) an indicator of a set of Uu measurement gaps (e.g., a minimum length of time for the positioning target wireless device 602 to be able to receive and measure Wi-Fi signals), (g) an indicator of a set of ranging modes that the positioning target wireless device 602 is capable of using to calculate a location of the positioning target wireless device 602, or an intermediary measurement that may be used to calculate a location of the positioning target wireless device 602, (h) an indicator of a set of preamble signals that the positioning target wireless device 602 is capable of receiving and measuring. (i) an indicator of a set of APs that the positioning target wireless device 602 is aware of, (j) an indicator of a positioning model mode that the positioning target wireless device 602 is capable of using to calculate a location of the positioning target wireless device 602, or an intermediary measurement that may be used to calculate a location of the positioning target wireless device 602, (k) an indicator of a positioning measurement that the positioning target wireless device 602 is capable of receiving and measuring, or (l) an indicator of a reporting trigger that the positioning target wireless device 602 is capable of using to trigger transmitting a set of reports based on the measurements/calculation. Moreover, 801 may be performed by the positioning component 198 in FIG. 1, 3, or 11.

At 802, the UE may receive a Wi-Fi positioning configuration including a set of measurement gaps for a reception of the set of Wi-Fi RSs. The Wi-Fi positioning configuration may include a set of Wi-Fi AP IDs associated with a transmission of the set of Wi-Fi RSs. The Wi-Fi positioning configuration may include a set of locations associated with the transmission of the set of Wi-Fi RSs. For example, 802 may be performed by the positioning target wireless device 602 in FIG. 6, which may receive a set of configurations 614. The set of configurations 614 may include a Wi-Fi positioning configuration including a set of measurement gaps for a reception of the set of positioning signals 620. The set of positioning signals 620 may include a set of Wi-Fi RSs. The Wi-Fi positioning configuration may include a set of Wi-Fi AP IDs associated with a transmission of the set of positioning signals 620. The Wi-Fi positioning configuration may include a set of locations associated with the transmission of the set of Wi-Fi RSs. In other words, the Wi-Fi configuration may identify Wi-Fi APs and/or locations of the identified Wi-Fi APs to the positioning target wireless device 602. Moreover, 802 may be performed by the positioning component 198 in FIG. 1, 3, or 11.

At 804, the UE may receive the set of Wi-Fi RSs during the set of measurement gaps. The set of Wi-Fi RSs may include at least one of a data packet or a NDP. For example, 804 may be performed by the positioning target wireless device 602 in FIG. 6, which may receive the set of positioning signals 620 from the set of positioning neighbor wireless devices 604 during the set of measurement gaps. The set of positioning signals 620 may include the set of Wi-Fi RSs. The set of Wi-Fi RSs may include at least one of a data packet or a NDP. The positioning target wireless device 602 may measure a preamble of a data packet or a preamble of a NDP. Moreover, 804 may be performed by the positioning component 198 in FIG. 1, 3, or 11.

At 806, the UE may measure the set of Wi-Fi RSs. The measured set of Wi-Fi RSs may include at least one of a CIR, a CFR, a PDP, a DP, an RSSI, or a RTT. For example, 806 may be performed by the positioning target wireless device 602 in FIG. 6, which may, at 624, measure the set of positioning signals 620. The set of positioning signals 620 may include the set of Wi-Fi RSs. At 624, the positioning target wireless device 602 may measure the set of Wi-Fi RSs by measuring at least one of a CIR, a CFR, a PDP, a DP, an RSSI, or a RTT. Moreover, 806 may be performed by the positioning component 198 in FIG. 1, 3, or 11.

At 808, the UE may calculate a position of the UE using a positioning model based on the measured set of Wi-Fi RSs. For example, 808 may be performed by the positioning target wireless device 602 in FIG. 6, which may, at 626, calculate a position of the positioning target wireless device 602 using a positioning model based on the measured set of Wi-Fi RSs. Moreover, 808 may be performed by the positioning component 198 in FIG. 1, 3, or 11.

At 810, the UE may transmit a report message including the calculated position of the UE. The report message may further include an indicator that the calculated location is associated with both the set of Wi-Fi RSs and the set of Uu RSs. The report message may further include an indicator that the calculated location is not associated with any signals other than the set of Wi-Fi RSs. The report message may further include a set of Wi-Fi access point AP IDs associated with the calculated location of the UE. For example, 810 may be performed by the positioning target wireless device 602 in FIG. 6, which may transmit the set of reports 628 to the positioning network entity 608. The set of reports 628 may include a report message including the calculated position of the positioning target wireless device 602. The report message may further include an indicator that the calculated location is associated with both the set of Wi-Fi RSs and the set of Uu RSs (i.e., the positioning target wireless device 602 calculated the location of the positioning target wireless device 602 based on measuring both Wi-Fi RSs and Uu RSs). The report message may further include an indicator that the calculated location is not associated with any signals other than the set of Wi-Fi RSs (i.e., the positioning target wireless device 602 calculated the location of the positioning target wireless device 602 based on Wi-Fi RSs and no other types of wireless signals). The report message may further include a set of Wi-Fi access point AP IDs associated with the calculated location of the positioning target wireless device 602 (e.g., the positioning target wireless device 602 calculated the location of the positioning target wireless device 602 based on Wi-Fi RSs transmitted by Wi-Fi APs identified by the AP IDs). Moreover, 810 may be performed by the positioning component 198 in FIG. 1, 3, or 11.

At 812, the UE may receive a Wi-Fi positioning configuration including a set of measurement gaps for a reception of the set of Wi-Fi RSs by receiving AD including the Wi-Fi positioning configuration. For example, 812 may be performed by the positioning target wireless device 602 in FIG. 6, which may receive the set of configurations 614 from the positioning network entity 608. The set of configurations 614 may include AD including the Wi-Fi positioning configuration. The Wi-Fi positioning configuration may configure the set of positioning signals 620. The set of positioning signals 620 may include a set of Wi-Fi positioning signals. Moreover, 812 may be performed by the positioning component 198 in FIG. 1, 3, or 11.

At 814, the UE may receive a Uu positioning configuration including a second set of measurement gaps for a second reception of a set of Uu RSs. The set of Uu RSs may include at least one of a PRS, a CSI-RS, an SSB, or an SRS. For example, 814 may be performed by the positioning target wireless device 602 in FIG. 6, which may receive the set of configurations 614. The set of configurations 614 may include a Uu positioning configuration including a second set of measurement gaps for a reception of the set of positioning signals 622. The set of positioning signals 622 may include a set of Uu RSs. The set of Uu RSs may include at least one of a PRS, a CSI-RS, an SSB, or an SRS. For example, the set of positioning neighbor wireless devices 606 may transmit a set of PRSs at the positioning target wireless device 602 as the set of positioning signals 622. Moreover, 814 may be performed by the positioning component 198 in FIG. 1, 3, or 11.

At 816, the UE may receive the set of Uu RSs during the second set of measurement gaps. For example, 816 may be performed by the positioning target wireless device 602 in FIG. 6, which may receive the set of positioning signals 622 from the set of positioning neighbor wireless devices 606 during the second set of measurement gaps. The set of set of positioning signals 622 may include the set of Uu RSs. Moreover, 816 may be performed by the positioning component 198 in FIG. 1, 3, or 11.

At 818, the UE may receive the set of Uu RSs from a plurality of TRPs. For example, 818 may be performed by the positioning target wireless device 602 in FIG. 6, which may receive the set of positioning signals 622 from the set of positioning neighbor wireless devices 606. The set of positioning signals 622 may include the set of Uu RSs. The set of positioning neighbor wireless devices 606 may include a plurality of TRPs. Moreover, 818 may be performed by the positioning component 198 in FIG. 1,3, or 11.

At 820, the UE may measure the set of Uu RSs. The measured set of Uu RSs may include at least one of a CIR, a CFR, a PDP, a DP, an RSRP, an RSRPP, an RSTD, or an AoD. For example, 820 may be performed by the positioning target wireless device 602 in FIG. 6, which may, at 626, measure the set of positioning signals 622. The set of positioning signals 622 may include the set of Uu RSs. The positioning target wireless device 602 may measure the set of Uu RSs by measuring at least one of a CIR, a CFR, a PDP, a DP, an RSRP, an RSRPP, an RSTD, or an AoD of the set of positioning signals 622. Moreover, 820 may be performed by the positioning component 198 in FIG. 1, 3, or 11.

At 822, the UE may calculate the position of the UE using the positioning model based on the measured set of Wi-Fi RSs by calculating the position of the UE using the positioning model further based on the measured set of Uu RSs. For example, 822 may be performed by the positioning target wireless device 602 in FIG. 6, which may, at 626, calculate the position/location of the positioning target wireless device 602 using the positioning model further based on the measured set of Uu RSs. Moreover, 822 may be performed by the positioning component 198 in FIG. 1, 3, or 11.

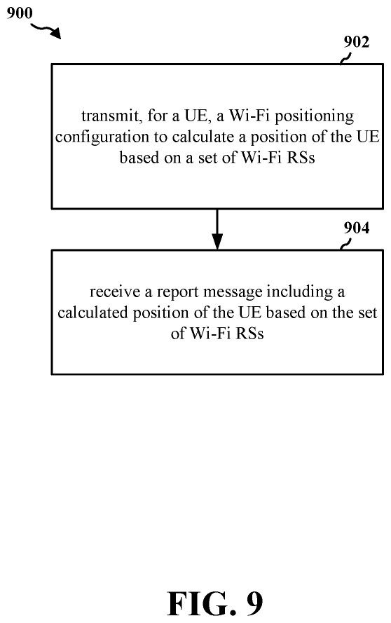

FIG. 9 is a flowchart 900 of a method of wireless communication. The method may be performed by a network entity (e.g., the base station 102, the base station 310; the core network 120; the one or more location servers 168; the LMF 166; the wireless device 402, the wireless device 406, the wireless device 502, the wireless device 506, the wireless device 522, the wireless device 526; the positioning network entity 608; the network entity 508, the network entity 1102, the network entity 1202, the network entity 1360; one of the set of positioning neighbor wireless devices 604, one of the set of positioning neighbor wireless devices 606). At 902, the network entity may transmit, for a UE, a Wi-Fi positioning configuration to calculate a position of the UE based on a set of Wi-Fi RSs. The Wi-Fi positioning configuration may include a set of measurement gaps associated with the set of Wi-Fi RSs. For example, 902 may be performed by the positioning network entity 608 in FIG. 6, which may transmit, for the positioning target wireless device 602, the set of configurations 614. The set of configurations 614 may include a Wi-Fi positioning configuration to calculate a position of the positioning target wireless device 602 based on the set of positioning signals 620. The set of positioning signals 620 may include a set of Wi-Fi RSs. The Wi-Fi positioning configuration may include a set of measurement gaps associated with the set of Wi-Fi RSs. Moreover, 902 may be performed by the positioning configuration component 199 in FIG. 1, 3, 12, or 13.

At 904, the network entity may receive a report message including a calculated position of the UE based on the set of Wi-Fi RSs. For example, 904 may be performed by the positioning network entity 608 in FIG. 6, which may receive the set of reports 628 from the positioning target wireless device 602. The set of reports 628 may include a report message including a calculated position of the positioning target wireless device 602 based on the set of positioning signals 620. The set of positioning signals 620 may include the set of Wi-Fi RSs. Moreover, 904 may be performed by the positioning configuration component 199 in FIG. 1, 3, 12, or 13.

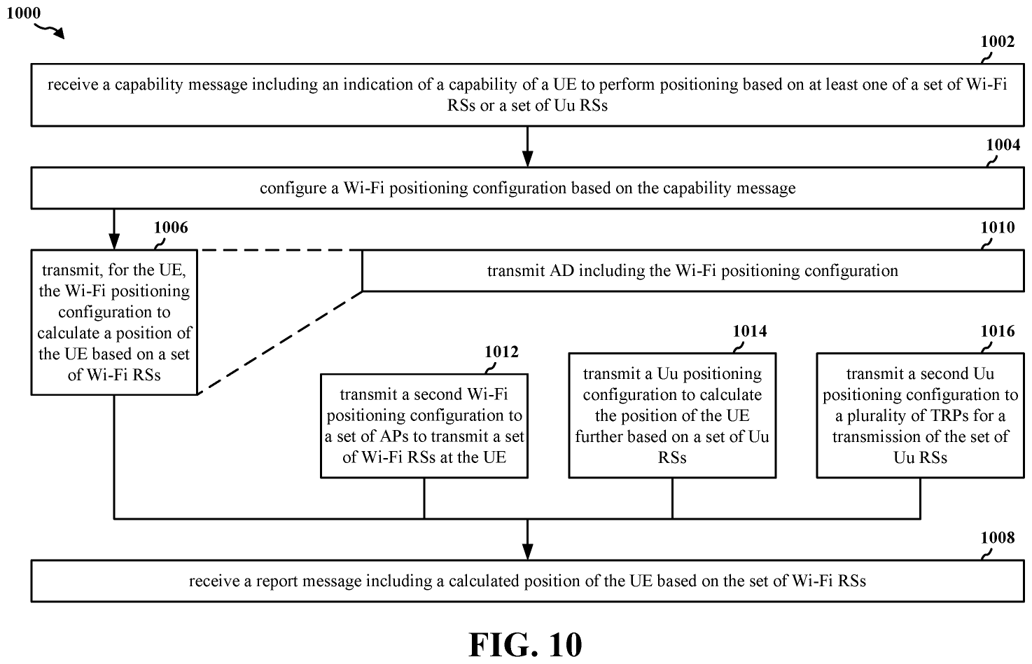

FIG. 10 is a flowchart 1000 of a method of wireless communication. The method may be performed by a network entity (e.g., the base station 102, the base station 310; the core network 120; the one or more location servers 168; the LMF 166; the wireless device 402, the wireless device 406, the wireless device 502, the wireless device 506, the wireless device 522, the wireless device 526; the positioning network entity 608; the network entity 508, the network entity 1102, the network entity 1202, the network entity 1360; one of the set of positioning neighbor wireless devices 604, one of the set of positioning neighbor wireless devices 606).

At 1002, the network entity may receive a capability message including an indication of a capability of a UE to perform positioning based on at least one of a set of Wi-Fi RSs or a set of Uu RSs. The indication of the capability may include at least one of (a) a first indicator of a supported Wi-Fi bandwidth, (b) a second indicator of a supported Uu bandwidth, (c) a third indicator of a set of supported Wi-Fi resources, (d) a fourth indicator of a set of supported Uu resources, (e) a fifth indicator of a set of supported Wi-Fi measurement gaps, (f) a sixth indicator of a set of supported Uu measurement gaps, (g) a seventh indicator of a set of supported ranging modes, (h) an eighth indicator of a set of supported preamble signals, (i) a ninth indicator of a set of supported APs, (j) a tenth indicator of a supported positioning model mode, (k) an eleventh indicator of a supported positioning measurement, or (l) a twelfth indicator of a supported reporting trigger. For example, 1002 may be performed by the positioning network entity 608 in FIG. 6, which may receive the capability 610 from the positioning target wireless device 602. The positioning target wireless device 602 may transmit a capability message, for example an LPP message, including the capability 610. The capability 610 may include an indication of a capability of the positioning target wireless device 602 to perform positioning based on at least one of a set of Wi-Fi RSs or a set of Uu RSs. The indication of the capability may include at least one of (a) an indicator of a Wi-Fi bandwidth that the positioning target wireless device 602 is capable of receiving and measuring. (b) an indicator of a Uu bandwidth that the positioning target wireless device 602 is capable of receiving and measuring. (c) an indicator of a set of Wi-Fi resources that the positioning target wireless device 602 is capable of receiving and measuring. (d) an indicator of a set of Uu resources that the positioning target wireless device 602 is capable of receiving and measuring, (c) an indicator of a set of Wi-Fi measurement gaps (e.g., a minimum length of time for the positioning target wireless device 602 to be able to receive and measure Wi-Fi signals), (f) an indicator of a set of Uu measurement gaps (e.g., a minimum length of time for the positioning target wireless device 602 to be able to receive and measure Wi-Fi signals), (g) an indicator of a set of ranging modes that the positioning target wireless device 602 is capable of using to calculate a location of the positioning target wireless device 602, or an intermediary measurement that may be used to calculate a location of the positioning target wireless device 602, (h) an indicator of a set of preamble signals that the positioning target wireless device 602 is capable of receiving and measuring. (i) an indicator of a set of APs that the positioning target wireless device 602 is aware of, (j) an indicator of a positioning model mode that the positioning target wireless device 602 is capable of using to calculate a location of the positioning target wireless device 602, or an intermediary measurement that may be used to calculate a location of the positioning target wireless device 602, (k) an indicator of a positioning measurement that the positioning target wireless device 602 is capable of receiving and measuring, or (l) an indicator of a reporting trigger that the positioning target wireless device 602 is capable of using to trigger transmitting a set of reports based on the measurements/calculation. Moreover, 1002 may be performed by the positioning configuration component 199 in FIG. 1, 3, 12, or 13. At 1004, the network entity may configure a Wi-Fi positioning configuration based on the capability message. For example, 1004 may be performed by the positioning network entity 608 in FIG. 6, which may, at 612, configure a Wi-Fi positioning configuration for the positioning target wireless device 602 based on the capability 610. Moreover, 1004 may be performed by the positioning configuration component 199 in FIG. 1, 3, 12, or 13.

At 1006, the network entity may transmit, for the UE, the Wi-Fi positioning configuration to calculate a position of the UE based on a set of Wi-Fi RSs. The Wi-Fi positioning configuration may include at least one of a set of Wi-Fi AP IDs associated with a transmission of the set of Wi-Fi RSs or a set of locations associated with the transmission of the set of Wi-Fi RSs. The Wi-Fi positioning configuration may include a set of measurement gaps associated with the set of Wi-Fi RSs. The set of Wi-Fi RSs may be associated with a plurality of APs. The set of Wi-Fi RSs may include at least one of a data packet or a NDP. For example, 1006 may be performed by the positioning network entity 608 in FIG. 6, which may transmit, for the positioning target wireless device 602, the set of configurations 614. The set of configurations 614 may include a Wi-Fi positioning configuration to calculate a position of the positioning target wireless device 602 based on the set of positioning signals 620. The set of positioning signals 620 may include a set of Wi-Fi RSs. The Wi-Fi positioning configuration may include a set of measurement gaps associated with the set of Wi-Fi RSs. The Wi-Fi positioning configuration may include at least one of a set of Wi-Fi AP IDs associated with a transmission of the set of positioning signals 620 or a set of locations associated with the transmission of the set of positioning signals 620. In other words, the Wi-Fi positioning configuration may include an indicator of which APs the positioning target wireless device 602 should receive and measure Wi-Fi positioning signals from, and/or a location of those APs. The set of positioning signals 620 may be associated with a plurality of APs. In other words, a plurality of APs may transmit set of positioning signals 620 to the positioning target wireless device 602. The set of positioning signals 620 may include at least one of a data packet or a NDP. Moreover, 1006 may be performed by the positioning configuration component 199 in FIG. 1, 3, 12, or 13.

At 1008, the network entity may receive a report message including a calculated position of the UE based on the set of Wi-Fi RSs. The report message may include an indicator that the calculated location is associated with both the set of Wi-Fi RSs and the set of Uu RSs. The report message may include an indicator that the calculated location is not associated with any signals other than the set of Wi-Fi RSs. The report message may include a set of Wi-Fi AP IDs associated with the calculated location of the UE. For example, 1008 may be performed by the positioning network entity 608 in FIG. 6, which may receive the set of reports 628 from the positioning target wireless device 602. The set of reports 628 may include a report message including a calculated position of the positioning target wireless device 602 based on the set of positioning signals 620. The set of positioning signals 620 may include the set of Wi-Fi RSs. The set of reports 628 may include an indicator that the calculated location is associated with both the set of Wi-Fi RSs and the set of Uu RSs. In other words, the set of reports 628 may indicate that the positioning target wireless device 602 calculated a location based on measurements of both Wi-Fi RSs and Uu RSs. The set of reports 628 may include an indicator that the calculated location is not associated with any signals other than the set of Wi-Fi RSs. In other words, the set of reports 628 may indicate that the positioning target wireless device 602 calculated the location based on measurements of Wi-Fi RSs and not measurements of other types of wireless signals. The set of reports 628 may include a set of Wi-Fi AP IDs associated with the calculated location of the UE. In other words, the set of reports 628 may indicate which Wi-Fi APs transmitted the Wi-Fi RSs that the positioning target wireless device 602 used to calculate its location. Moreover, 1008 may be performed by the positioning configuration component 199 in FIG. 1, 3, 12, or 13.

At 1010, the network entity may transmit, for the UE, the Wi-Fi positioning configuration to calculate a position of the UE based on a set of Wi-Fi RSs by transmitting AD including the Wi-Fi positioning configuration. For example, 1010 may be performed by the positioning network entity 608 in FIG. 6, which may transmit the set of configurations 614 to the positioning target wireless device 602. The set of configurations 614 may include AD having the Wi-Fi positioning configuration. Moreover, 1010 may be performed by the positioning configuration component 199 in FIG. 1, 3, 12, or 13.

At 1012, the network entity may transmit a second Wi-Fi positioning configuration to a set of APs to transmit a set of Wi-Fi RSs at the UE. For example, 1012 may be performed by the positioning network entity 608 in FIG. 6, which may transmit the set of configurations 616 to the set of positioning neighbor wireless devices 604. The set of configurations 616 may include a Wi-Fi positioning configuration to transmit the set of positioning signals 620 to the positioning target wireless device 602. The set of positioning signals 620 may include a set of Wi-Fi RSs. Moreover, 1012 may be performed by the positioning configuration component 199 in FIG. 1, 3, 12, or 13.

At 1014, the network entity may transmit a Uu positioning configuration to calculate the position of the UE further based on a set of Uu RSs. The Uu positioning configuration may include a second set of measurement gaps associated with the set of Uu RSs. The calculated location of the UE may be further based on the set of Uu RSs. For example, 1014 may be performed by the positioning network entity 608 in FIG. 6, which may transmit the set of configurations 614 to the positioning target wireless device 602. The set of configurations 614 may include a Uu positioning configuration to calculate the position of the positioning target wireless device 602 further based on the set of positioning signals 622. The set of positioning signals 622 may include a set of Uu RSs. In some aspects, the Uu positioning configuration and the Wi-Fi positioning configuration may be a single configuration. In some aspects, the Uu positioning configuration and the Wi-Fi positioning configuration may be more than one configuration. The Uu positioning configuration may include a second set of measurement gaps associated with the set of Uu RSs. In other words, the Uu positioning configuration may configure measurement gaps for the positioning target wireless device 602 to use to receive the set of positioning signals 620 for measuring at 624. The calculated location of the positioning target wireless device 602 at 626 may be further based on the set of Uu RSs. In other words, the positioning model may use the measurements of the Uu RSs in addition to measurements of the Wi-Fi RSs to calculate a location of the positioning target wireless device 602, or an intermediary measurement that may be used to calculate the location of the positioning target wireless device 602. Moreover, 1014 may be performed by the positioning configuration component 199 in FIG. 1, 3, 12, or 13.

At 1016, the network entity may transmit a second Uu positioning configuration to a plurality of TRPs for a transmission of the set of Uu RSs. The set of Uu RSs may include at least one of a PRS, a CSI-RS, an SSB, or an SRS. For example, 1016 may be performed by the positioning network entity 608 in FIG. 6, which may transmit the set of configurations 618 to the set of positioning neighbor wireless devices 606. The set of configurations 618 may include a second Uu positioning configuration for a transmission of the set of positioning signals 622. The set of positioning signals 622 may include the set of Uu RSs. The set of positioning neighbor wireless devices 606 may include a plurality of TRPs. The set of Uu RSs may include at least one of a PRS, a CSI-RS, an SSB, or an SRS. For example, the set of positioning neighbor wireless devices 606 may transmit a set of PRSs as the set of positioning signals 622 to the positioning target wireless device 602. Moreover, 1016 may be performed by the positioning configuration component 199 in FIG. 1, 3, 12, or 13.

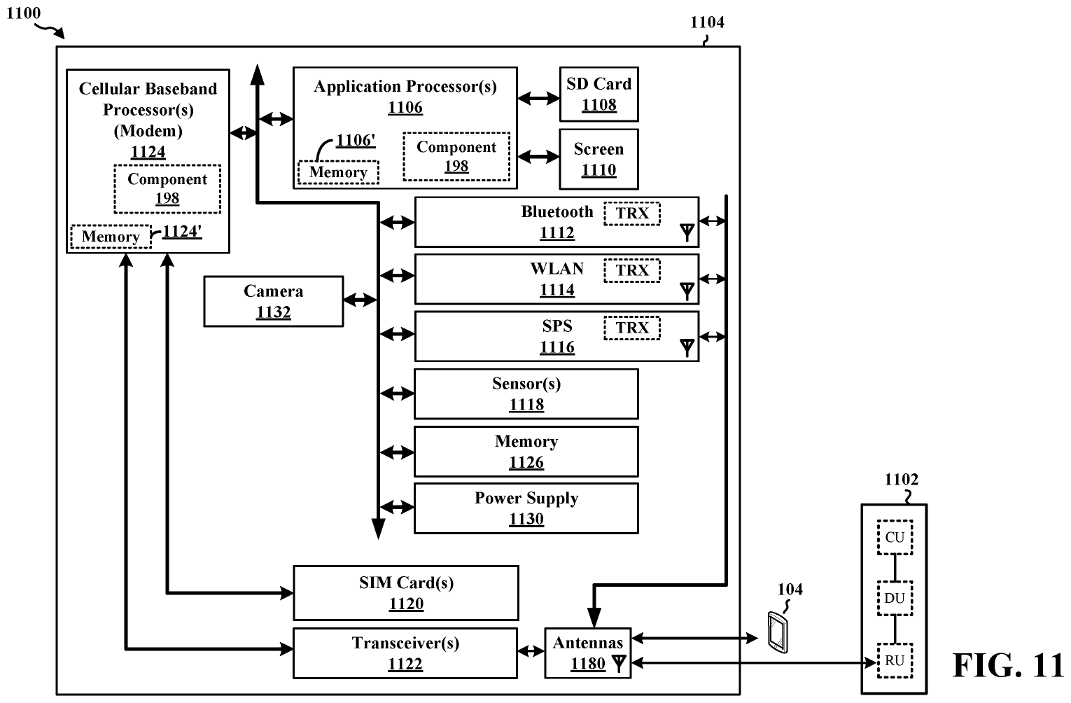

FIG. 11 is a diagram 1100 illustrating an example of a hardware implementation for an apparatus 1104. The apparatus 1104 may be a UE, a component of a UE, or may implement UE functionality. In some aspects, the apparatus 904 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive a Wi-Fi positioning configuration including a set of measurement gaps for a reception of a set of Wi-Fi RSs. The component 198 may be configured to receive the set of Wi-Fi RSs during the set of measurement gaps. The component 198 may be configured to measure the set of Wi-Fi RSs. The component 198 may be configured to calculate a position of the apparatus 1104 using a positioning model based on the measured set of Wi-Fi RSs. The component 198 may be configured to transmit a report message including the calculated position of the apparatus 1104. The component 198 may be configured to receive a Uu positioning configuration including a second set of measurement gaps for a second reception of a set of Uu RSs. The component 198 may be configured to receive the set of Uu RSs during the second set of measurement gaps. The component 198 may be configured to measure the set of Uu RSs. The component 198 may be configured to calculate the position of the apparatus 1104 using the positioning model further based on the measured set of Uu RSs. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving a Wi-Fi positioning configuration including a set of measurement gaps for a reception of a set of Wi-Fi RSs. The apparatus 1104 may include means for receiving the set of Wi-Fi RSs during the set of measurement gaps. The apparatus 1104 may include means for measuring the set of Wi-Fi RSs. The apparatus 1104 may include means for calculating a location of the apparatus 1104 using a positioning model based on the measured set of Wi-Fi RSs. The apparatus 1104 may include means for transmitting a report message including the calculated location of the apparatus 1104. The Wi-Fi positioning configuration may include at least one of a set of Wi-Fi AP IDs associated with a transmission of the set of Wi-Fi RSs or a set of locations associated with the transmission of the set of Wi-Fi RSs. The apparatus 1104 may include means for receiving the set of Wi-Fi RSs by receiving the set of Wi-Fi RSs from a plurality of APs. The set of Wi-Fi RSs may include at least one of a data packet or a NDP. The measured set of Wi-Fi RSs may include at least one of a CIR, a CFR, a PDP, a DP, an RSSI, or a RTT. The apparatus 1104 may include means for receiving a Uu positioning configuration including a second set of measurement gaps for a second reception of a set of Uu RSs. The apparatus 1104 may include means for receiving the set of Uu RSs during the second set of measurement gaps. The apparatus 1104 may include means for measuring the set of Uu RSs. The apparatus 1104 may include means for calculating the location of the apparatus 1104 using the positioning model further based on the measured set of Uu RSs. The set of Uu RSs may include at least one of a PRS, a CSI-RS, an SSB, or an SRS. The apparatus 1104 may include means for receiving the set of Uu RSs by receiving the set of Uu RSs from a plurality of TRPs. The measured set of Uu RSs may include at least one of a CIR, a CFR, a PDP, a DP, an RSRP, an RSRPP, an RSTD, or an AoD. The report message may include an indicator that the calculated location is associated with both the set of Wi-Fi RSs and the set of Uu RSs. The report message may include an indicator that the calculated location is not associated with any signals other than the set of Wi-Fi RSs. The report message may include a set of Wi-Fi AP IDs associated with the calculated location of the apparatus 1104. The apparatus 1104 may include means for transmitting a capability message including an indication of a capability of the apparatus 1104 to perform positioning based on at least one of the set of Wi-Fi RSs or a set of Uu RSs. The transmission of the capability message may be before the reception of the Wi-Fi positioning configuration. The indication of the capability may include at least one of (a) a first indicator of a supported Wi-Fi bandwidth, (b) a second indicator of a supported Uu bandwidth, (c) a third indicator of a set of supported Wi-Fi resources, (d) a fourth indicator of a set of supported Uu resources, (c) a fifth indicator of a set of supported Wi-Fi measurement gaps, (f) a sixth indicator of a set of supported Uu measurement gaps, (g) a seventh indicator of a set of supported ranging modes, (h) an eighth indicator of a set of supported preamble signals, (i) a ninth indicator of a set of supported APs, (j) a tenth indicator of a supported positioning model mode, (k) an eleventh indicator of a supported positioning measurement, or (l) a twelfth indicator of a supported reporting trigger. The apparatus 1104 may include means for receiving the Wi-Fi positioning configuration by receiving AD including the Wi-Fi positioning configuration. The apparatus 1104 may include means for 988. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

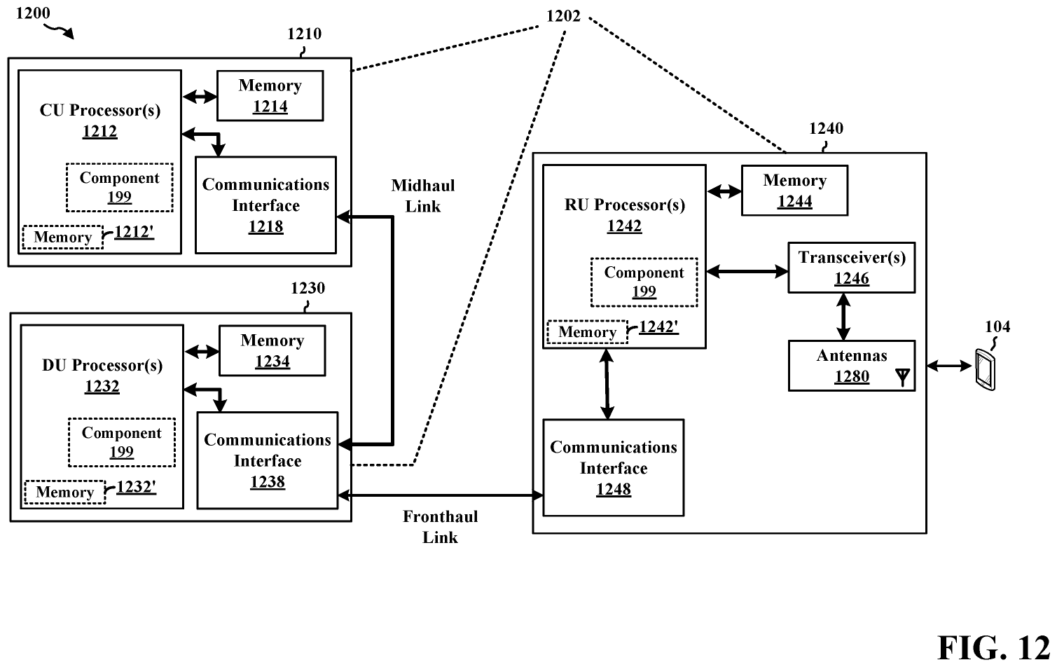

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, a Wi-Fi positioning configuration to calculate a location of the UE based on a set of Wi-Fi RSs. The Wi-Fi positioning configuration may include a set of measurement gaps associated with the set of Wi-Fi RSs. The component 199 may be configured to receive a report message including a calculated location of the UE based on the set of Wi-Fi RSs. The component 199 may be configured to transmit a Uu positioning configuration to calculate the location of the UE further based on a set of Uu RSs. The Uu positioning configuration may include a second set of measurement gaps associated with the set of Uu RSs. The calculated location of the UE may be further based on the set of Uu RSs. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting, for a UE, a Wi-Fi positioning configuration to calculate a location of the UE based on a set of Wi-Fi RSs. The Wi-Fi positioning configuration may include a set of measurement gaps associated with the set of Wi-Fi RSs. The network entity 1202 may include means for receiving a report message including a calculated location of the UE based on the set of Wi-Fi RSs. The Wi-Fi positioning configuration may include at least one of a set of Wi-Fi AP IDs associated with a transmission of the set of Wi-Fi RSs or a set of locations associated with the transmission of the set of Wi-Fi RSs. The network entity 1202 may include means for transmitting a second Wi-Fi positioning configuration to a set of APs to transmit a set of Wi-Fi RSs at the UE. The set of Wi-Fi RSs may be associated with a plurality of APs. The set of Wi-Fi RSs may include at least one of a data packet or a NDP. The network entity 1202 may include means for transmitting a Uu positioning configuration to calculate the location of the UE further based on a set of Uu RSs. The Uu positioning configuration may include a second set of measurement gaps associated with the set of Uu RSs. The calculated location of the UE may be further based on the set of Uu RSs. The set of Uu RSs may include at least one of a PRS, a CSI-RS, an SSB, or an SRS. The network entity 1202 may include means for transmitting a second Uu positioning configuration to a plurality of TRPs for a transmission of the set of Uu RSs. The report message may include an indicator that the calculated location is associated with both the set of Wi-Fi RSs and the set of Uu RSs. The report message may include an indicator that the calculated location is not associated with any signals other than the set of Wi-Fi RSs. The report message may include a set of Wi-Fi AP IDs associated with the calculated location of the UE. The network entity 1202 may include means for receiving a capability message including an indication of a capability of the UE to perform positioning based on at least one of the set of Wi-Fi RSs or a set of Uu RSs. The network entity 1202 may include means for configuring the Wi-Fi positioning configuration based on the capability message. The indication of the capability may include at least one of (a) a first indicator of a supported Wi-Fi bandwidth, (b) a second indicator of a supported Uu bandwidth, (c) a third indicator of a set of supported Wi-Fi resources, (d) a fourth indicator of a set of supported Uu resources, (e) a fifth indicator of a set of supported Wi-Fi measurement gaps, (f) a sixth indicator of a set of supported Uu measurement gaps, (g) a seventh indicator of a set of supported ranging modes, (h) an eighth indicator of a set of supported preamble signals, (i) a ninth indicator of a set of supported APs, (j) a tenth indicator of a supported positioning model mode, (k) an eleventh indicator of a supported positioning measurement, or (l) a twelfth indicator of a supported reporting trigger. The network entity 1202 may include means for transmitting the Wi-Fi positioning configuration by transmitting AD including the Wi-Fi positioning configuration. The network entity 1202 may include an LMF. The Wi-Fi positioning configuration may include a set of measurement gaps associated with the set of Wi-Fi RSs. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

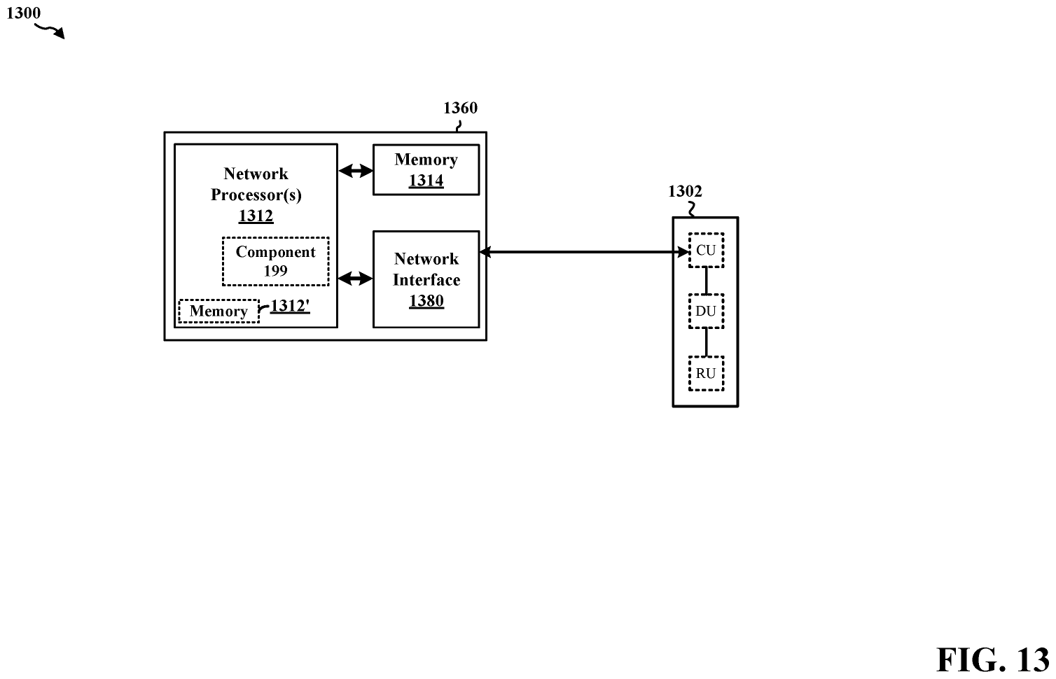

FIG. 13 is a diagram 1300 illustrating an example of a hardware implementation for a network entity 1360. In one example, the network entity 1360 may be within the core network 120. The network entity 1360 may include at least one network processor 1312. The network processor(s) 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The network processor(s) 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, a Wi-Fi positioning configuration to calculate a location of the UE based on a set of Wi-Fi RSs. The Wi-Fi positioning configuration may include a set of measurement gaps associated with the set of Wi-Fi RSs. The component 199 may be configured to receive a report message including a calculated location of the UE based on the set of Wi-Fi RSs. The component 199 may be configured to transmit a Uu positioning configuration to calculate the location of the UE further based on a set of Uu RSs. The Uu positioning configuration may include a second set of measurement gaps associated with the set of Uu RSs. The calculated location of the UE may be further based on the set of Uu RSs. The component 199 may be within the network processor(s) 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1360 may include a variety of components configured for various functions. In one configuration, the network entity 1360 may include means for transmitting, for a UE, a Wi-Fi positioning configuration to calculate a location of the UE based on a set of Wi-Fi RSs. The Wi-Fi positioning configuration may include a set of measurement gaps associated with the set of Wi-Fi RSs. The network entity 1360 may include means for receiving a report message including a calculated location of the UE based on the set of Wi-Fi RSs. The Wi-Fi positioning configuration may include at least one of a set of Wi-Fi AP IDs associated with a transmission of the set of Wi-Fi RSs or a set of locations associated with the transmission of the set of Wi-Fi RSs. The network entity 1360 may include means for transmitting a second Wi-Fi positioning configuration to a set of APs to transmit a set of Wi-Fi RSs at the UE. The set of Wi-Fi RSs may be associated with a plurality of APs. The set of Wi-Fi RSs may include at least one of a data packet or a NDP. The network entity 1360 may include means for transmitting a Uu positioning configuration to calculate the location of the UE further based on a set of Uu RSs. The Uu positioning configuration may include a second set of measurement gaps associated with the set of Uu RSs. The calculated location of the UE may be further based on the set of Uu RSs. The set of Uu RSs may include at least one of a PRS, a CSI-RS, an SSB, or an SRS. The network entity 1360 may include means for transmitting a second Uu positioning configuration to a plurality of TRPs for a transmission of the set of Uu RSs. The report message may include an indicator that the calculated location is associated with both the set of Wi-Fi RSs and the set of Uu RSs. The report message may include an indicator that the calculated location is not associated with any signals other than the set of Wi-Fi RSs. The report message may include a set of Wi-Fi AP IDs associated with the calculated location of the UE. The network entity 1360 may include means for receiving a capability message including an indication of a capability of the UE to perform positioning based on at least one of the set of Wi-Fi RSs or a set of Uu RSs. The network entity 1360 may include means for configuring the Wi-Fi positioning configuration based on the capability message. The indication of the capability may include at least one of (a) a first indicator of a supported Wi-Fi bandwidth, (b) a second indicator of a supported Uu bandwidth, (c) a third indicator of a set of supported Wi-Fi resources, (d) a fourth indicator of a set of supported Uu resources, (e) a fifth indicator of a set of supported Wi-Fi measurement gaps, (f) a sixth indicator of a set of supported Uu measurement gaps, (g) a seventh indicator of a set of supported ranging modes, (h) an eighth indicator of a set of supported preamble signals, (i) a ninth indicator of a set of supported APs, (j) a tenth indicator of a supported positioning model mode, (k) an eleventh indicator of a supported positioning measurement, or (l) a twelfth indicator of a supported reporting trigger. The network entity 1360 may include means for transmitting the Wi-Fi positioning configuration by transmitting AD including the Wi-Fi positioning configuration. The network entity 1360 may include an LMF. The Wi-Fi positioning configuration may include a set of measurement gaps associated with the set of Wi-Fi RSs. The means may be the component 199 of the network entity 1360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only. A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may send the data to a component of the device. A device configured to “obtain” data, such as a transmission, signal, or message, may receive, for example with a transceiver, may obtain the data from a device that receives the data, or may receive the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving a Wi-Fi positioning configuration comprising a set of measurement gaps for a reception of a set of Wi-Fi reference signals (RSs); receiving the set of Wi-Fi RSs during the set of measurement gaps; measuring the set of Wi-Fi RSs; calculating a location of the UE using a positioning model based on the measured set of Wi-Fi RSs; and transmitting a report message comprising the calculated location of the UE.

Aspect 2 is the method of aspect 1, wherein the Wi-Fi positioning configuration comprises at least one of: a set of Wi-Fi access point (AP) identifiers (IDs) associated with a transmission of the set of Wi-Fi RSs; or a set of locations associated with the transmission of the set of Wi-Fi RSs.

Aspect 3 is the method of either of aspects 1 or 2, wherein receiving the set of Wi-Fi RSs comprises receiving the set of Wi-Fi RSs from a plurality of access points (APs).

Aspect 4 is the method of any of aspects 1 to 3, wherein the set of Wi-Fi RSs comprises at least one of a data packet or a null-data packet (NDP).

Aspect 5 is the method of any of aspects 1 to 4, wherein the measured set of Wi-Fi RSs comprises at least one of: a channel impulse response (CIR); a channel frequency response (CFR); a power delay profile (PDP); a delay profile (DP); a reference signal strength indicator (RSSI); or a round-trip time (RTT).

Aspect 6 is the method of any of aspects 1 to 5, further comprising: receiving a UE-to-universal mobile telecommunications system terrestrial radio access network (UE-UTRAN) (Uu) positioning configuration comprising a second set of measurement gaps for a second reception of a set of Uu RSs; receiving the set of Uu RSs during the second set of measurement gaps; and measuring the set of Uu RSs, wherein calculating the location of the UE using the positioning model is further based on the measured set of Uu RSs.

Aspect 7 is the method of aspect 6, wherein the set of Uu RSs comprises at least one of a positioning reference signal (PRS), a channel state information (CSI) reference signal (CSI-RS), a synchronization signal block (SSB), or a sounding reference signal (SRS).

Aspect 8 is the method of either of aspects 6 or 7, wherein receiving the set of Uu RSs comprises receiving the set of Uu RSs from a plurality of transmission reception points (TRPs).

Aspect 9 is the method of any of aspects 6 to 8, wherein the measured set of Uu RSs comprises at least one of: a channel impulse response (CIR); a channel frequency response (CFR); a power delay profile (PDP); a delay profile (DP); a reference signal received power (RSRP); a reference signal received power path (RSRPP); a reference signal time difference (RSTD); or an angle of departure (AoD).

Aspect 10 is the method of any of aspects 6 to 9, wherein the report message further comprises an indicator that the calculated location is associated with both the set of Wi-Fi RSs and the set of Uu RSs.

Aspect 11 is the method of any of aspects 1 to 10, wherein the report message further comprises an indicator that the calculated location is not associated with any signals other than the set of Wi-Fi RSs.

Aspect 12 is the method of any of aspects 1 to 11, wherein the report message further comprises a set of Wi-Fi access point (AP) identifiers (IDs) associated with the calculated location of the UE.

Aspect 13 is the method of any of aspects 1 to 12, further comprising transmitting a capability message comprising an indication of a capability of the UE to perform positioning based on at least one of the set of Wi-Fi RSs or a set of Uu RSs, wherein the transmission of the capability message is before the reception of the Wi-Fi positioning configuration.

Aspect 14 is the method of aspect 13, wherein the indication of the capability comprises at least one of: a first indicator of a supported Wi-Fi bandwidth; a second indicator of a supported Uu bandwidth; a third indicator of a set of supported Wi-Fi resources; a fourth indicator of a set of supported Uu resources; a fifth indicator of a set of supported Wi-Fi measurement gaps; a sixth indicator of a set of supported Uu measurement gaps; a seventh indicator of a set of supported ranging modes; an eighth indicator of a set of supported preamble signals; a ninth indicator of a set of supported access points (APs); a tenth indicator of a supported positioning model mode; an eleventh indicator of a supported positioning measurement; or a twelfth indicator of a supported reporting trigger.

Aspect 15 is the method of any of aspects 1 to 14, wherein receiving the Wi-Fi positioning configuration comprises receiving assistance data (AD) comprising the Wi-Fi positioning configuration.

Aspect 16 is a method of wireless communication at a network entity, comprising: transmitting, for a user equipment (UE), a Wi-Fi positioning configuration to calculate a position of the UE based on a set of Wi-Fi reference signals (RSs), wherein the Wi-Fi positioning configuration comprises a set of measurement gaps associated with the set of Wi-Fi RSs; and receiving a report message comprising a calculated location of the UE based on the set of Wi-Fi RSs.

Aspect 17 is the method of aspect 16, wherein the Wi-Fi positioning configuration comprises at least one of: a set of Wi-Fi access point (AP) identifiers (IDs) associated with a transmission of the set of Wi-Fi RSs; or a set of locations associated with the transmission of the set of Wi-Fi RSs.

Aspect 18 is the method of either of aspects 16 or 17, further comprising transmitting a second Wi-Fi positioning configuration to a set of access points (APs) to transmit a set of Wi-Fi RSs at the UE.

Aspect 19 is the method of any of aspects 16 to 18, wherein the set of Wi-Fi RSs is associated with a plurality of access points (APs).

Aspect 20 is the method of any of aspects 16 to 19, wherein the set of Wi-Fi RSs comprises at least one of a data packet or a null-data packet (NDP).

Aspect 21 is the method of any of aspects 16 to 20, further comprising: transmitting a UE-to-universal mobile telecommunications system terrestrial radio access network (UE-UTRAN) (Uu) positioning configuration to calculate the location of the UE further based on a set of Uu RSs, wherein the Uu positioning configuration comprises a second set of measurement gaps associated with the set of Uu RSs, wherein the calculated location of the UE is further based on the set of Uu RSs.

Aspect 22 is the method of aspect 21, wherein the set of Uu RSs comprises at least one of a positioning reference signal (PRS), a channel state information (CSI) reference signal (CSI-RS), a synchronization signal block (SSB), or a sounding reference signal (SRS).

Aspect 23 is the method of either of aspects 21 or 22, further comprising transmitting a second Uu positioning configuration to a plurality of transmission reception points (TRPs) for a transmission of the set of Uu RSs.

Aspect 24 is the method of any of aspects 21 to 23, wherein the report message further comprises an indicator that the calculated location is associated with both the set of Wi-Fi RSs and the set of Uu RSs.

Aspect 25 is the method of any of aspects 16 to 24, wherein the report message further comprises an indicator that the calculated location is not associated with any signals other than the set of Wi-Fi RSs.

Aspect 26 is the method of any of aspects 16 to 25, wherein the report message further comprises a set of Wi-Fi access point (AP) identifiers (IDs) associated with the calculated location of the UE.

Aspect 27 is the method of any of aspects 16 to 26, further comprising: receiving a capability message comprising an indication of a capability of the UE to perform positioning based on at least one of the set of Wi-Fi RSs or a set of Uu RSs; and configuring the Wi-Fi positioning configuration based on the capability message.

Aspect 28 is the method of aspect 27, wherein the indication of the capability comprises at least one of: a first indicator of a supported Wi-Fi bandwidth; a second indicator of a supported Uu bandwidth; a third indicator of a set of supported Wi-Fi resources; a fourth indicator of a set of supported Uu resources; a fifth indicator of a set of supported Wi-Fi measurement gaps; a sixth indicator of a set of supported Uu measurement gaps; a seventh indicator of a set of supported ranging modes; an eighth indicator of a set of supported preamble signals; a ninth indicator of a set of supported access points (APs); a tenth indicator of a supported positioning model mode; an eleventh indicator of a supported positioning measurement; or a twelfth indicator of a supported reporting trigger.

Aspect 29 is the method of any of aspects 16 to 28, wherein transmitting the Wi-Fi positioning configuration comprises transmitting assistance data (AD) comprising the Wi-Fi positioning configuration.

Aspect 30 is the method of any of aspects 16 to 29, wherein the network entity comprises a location management function (LMF).

Aspect 31 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 30.

Aspect 32 is an apparatus for wireless communication, comprising means for performing each step in the method of any of aspects 1 to 30.

Aspect 33 is the apparatus of any of aspects 1 to 30, further comprising a transceiver configured to receive or to transmit in association with the method of any of aspects 1 to 30.

Aspect 34 is a computer-readable medium (e.g., a non-transitory computer-readable medium) storing computer executable code, the code when executed by at least one processor causes the at least one processor to perform the method of any of aspects 1 to 30.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive a Wi-Fi positioning configuration comprising a set of measurement gaps for a reception of a set of Wi-Fi reference signals (RSs);
receive the set of Wi-Fi RSs during the set of measurement gaps;
measure the set of Wi-Fi RSs;
calculate a location of the UE using a positioning model based on the measured set of Wi-Fi RSs; and
transmit a report message comprising the calculated location of the UE.

2. The apparatus of claim 1, wherein the Wi-Fi positioning configuration comprises at least one of:
a set of Wi-Fi access point (AP) identifiers (IDs) associated with a transmission of the set of Wi-Fi RSs; or
a set of locations associated with the transmission of the set of Wi-Fi RSs.

3. The apparatus of claim 1, wherein, to receive the set of Wi-Fi RSs, the at least one processor, individually or in any combination, is configured to:
receive the set of Wi-Fi RSs from a plurality of access points (APs).

4. The apparatus of claim 1, wherein the set of Wi-Fi RSs comprises at least one of a data packet or a null-data packet (NDP).

5. The apparatus of claim 1, wherein the measured set of Wi-Fi RSs comprises at least one of:
a channel impulse response (CIR);
a channel frequency response (CFR);
a power delay profile (PDP),
a delay profile (DP),
a reference signal strength indicator (RSSI); or
a round-trip time (RTT).

6. The apparatus of claim 1, wherein the at least one processor, individually or in any combination, is further configured to:
receive a UE-to-universal mobile telecommunications system terrestrial radio access network (UE-UTRAN) (Uu) positioning configuration comprising a second set of measurement gaps for a second reception of a set of Uu RSs;
receive the set of Uu RSs during the second set of measurement gaps; and
measure the set of Uu RSs, wherein, to calculate the location of the UE using the positioning model, the at least one processor, individually or in any combination, is configured to calculate the location of the UE using the positioning model further based on the measured set of Uu RSs.

7. The apparatus of claim 6, wherein the set of Uu RSs comprises at least one of a positioning reference signal (PRS), a channel state information (CSI) reference signal (CSI-RS), a synchronization signal block (SSB), or a sounding reference signal (SRS).

8. The apparatus of claim 6, wherein, to receive the set of Uu RSs, the at least one processor, individually or in any combination, is configured to receive the set of Uu RSs from a plurality of transmission reception points (TRPs).

9. The apparatus of claim 6, wherein the measured set of Uu RSs comprises at least one of:
a channel impulse response (CIR);
a channel frequency response (CFR);
a power delay profile (PDP),
a delay profile (DP),
a reference signal received power (RSRP);
a reference signal received power path (RSRPP);
a reference signal time difference (RSTD); or
an angle of departure (AoD).

10. The apparatus of claim 6, wherein the report message further comprises an indicator that the calculated location is associated with both the set of Wi-Fi RSs and the set of Uu RSs.

11. The apparatus of claim 1, wherein the report message further comprises an indicator that the calculated location is not associated with any signals other than the set of Wi-Fi RSs.

12. The apparatus of claim 1, wherein the report message further comprises a set of Wi-Fi access point (AP) identifiers (IDs) associated with the calculated location of the UE.

13. The apparatus of claim 1, wherein the at least one processor, individually or in any combination, is further configured to:
transmit a capability message comprising an indication of a capability of the UE to perform positioning based on at least one of the set of Wi-Fi RSs or a set of Uu RSs, wherein the transmission of the capability message is before the reception of the Wi-Fi positioning configuration.

14. The apparatus of claim 13, wherein the indication of the capability comprises at least one of:
a first indicator of a supported Wi-Fi bandwidth;
a second indicator of a supported Uu bandwidth;
a third indicator of a set of supported Wi-Fi resources;
a fourth indicator of a set of supported Uu resources;
a fifth indicator of a set of supported Wi-Fi measurement gaps;
a sixth indicator of a set of supported Uu measurement gaps;
a seventh indicator of a set of supported ranging modes;
an eighth indicator of a set of supported preamble signals;
a ninth indicator of a set of supported access points (APs);
a tenth indicator of a supported positioning model mode;
an eleventh indicator of a supported positioning measurement; or
a twelfth indicator of a supported reporting trigger.

15. The apparatus of claim 1, wherein, to receive the Wi-Fi positioning configuration, the at least one processor, individually or in any combination, is configured to:
receive assistance data (AD) comprising the Wi-Fi positioning configuration.

16. An apparatus for wireless communication at a network entity, comprising:
at least one memory; and
at least one processor coupled to the at least one memory and, based at least in part on information stored in the at least one memory, the at least one processor, individually or in any combination, is configured to:
transmit, for a user equipment (UE), a Wi-Fi positioning configuration to calculate a location of the UE based on a set of Wi-Fi reference signals (RSs), wherein the Wi-Fi positioning configuration comprises a set of measurement gaps associated with the set of Wi-Fi RSs; and
receive a report message comprising a calculated location of the UE based on the set of Wi-Fi RSs.

17. The apparatus of claim 16, wherein the Wi-Fi positioning configuration comprises at least one of:
a set of Wi-Fi access point (AP) identifiers (IDs) associated with a transmission of the set of Wi-Fi RSs; or
a set of locations associated with the transmission of the set of Wi-Fi RSs.

18. The apparatus of claim 16, wherein the at least one processor, individually or in any combination, is further configured to:
transmit a second Wi-Fi positioning configuration to a set of access points (APs) to transmit a set of Wi-Fi RSs at the UE.

19. The apparatus of claim 16, wherein the set of Wi-Fi RSs is associated with a plurality of access points (APs).

20. The apparatus of claim 16, wherein the at least one processor, individually or in any combination, is further configured to:
transmit a UE-to-universal mobile telecommunications system terrestrial radio access network (UE-UTRAN) (Uu) positioning configuration to calculate the location of the UE further based on a set of Uu RSs, wherein the Uu positioning configuration comprises a second set of measurement gaps associated with the set of Uu RSs, wherein the calculated location of the UE is further based on the set of Uu RSs.

21. The apparatus of claim 20, wherein the set of Uu RSs comprises at least one of a positioning reference signal (PRS), a channel state information (CSI) reference signal (CSI-RS), a synchronization signal block (SSB), or a sounding reference signal (SRS).

22. The apparatus of claim 20, wherein the at least one processor, individually or in any combination, is further configured to:
transmit a second Uu positioning configuration to a plurality of transmission reception points (TRPs) for a transmission of the set of Uu RSs.

23. The apparatus of claim 20, wherein the report message further comprises an indicator that the calculated location is associated with both the set of Wi-Fi RSs and the set of Uu RSs.

24. The apparatus of claim 16, wherein the report message further comprises an indicator that the calculated location is not associated with any signals other than the set of Wi-Fi RSs.

25. The apparatus of claim 16, wherein the report message further comprises a set of Wi-Fi access point (AP) identifiers (IDs) associated with the calculated location of the UE.

26. The apparatus of claim 16, wherein the at least one processor, individually or in any combination, is further configured to:
receive a capability message comprising an indication of a capability of the UE to perform positioning based on at least one of the set of Wi-Fi RSs or a set of Uu RSs; and
configure the Wi-Fi positioning configuration based on the capability message.

27. The apparatus of claim 26, wherein the indication of the capability comprises at least one of:
a first indicator of a supported Wi-Fi bandwidth;
a second indicator of a supported Uu bandwidth;
a third indicator of a set of supported Wi-Fi resources;
a fourth indicator of a set of supported Uu resources;
a fifth indicator of a set of supported Wi-Fi measurement gaps;
a sixth indicator of a set of supported Uu measurement gaps;
a seventh indicator of a set of supported ranging modes;
an eighth indicator of a set of supported preamble signals;
a ninth indicator of a set of supported access points (APs);
a tenth indicator of a supported positioning model mode;
an eleventh indicator of a supported positioning measurement; or
a twelfth indicator of a supported reporting trigger.

28. The apparatus of claim 16, wherein, to transmit the Wi-Fi positioning configuration, the at least one processor, individually or in any combination, is configured to:
transmit assistance data (AD) comprising the Wi-Fi positioning configuration.

29. A method of wireless communication at a user equipment (UE), comprising:
receiving a Wi-Fi positioning configuration comprising a set of measurement gaps for a reception of a set of Wi-Fi reference signals (RSs);
receiving the set of Wi-Fi RSs during the set of measurement gaps;
measuring the set of Wi-Fi RSs;
calculating a position of the UE using a positioning model based on the measured set of Wi-Fi RSs; and
transmitting a report message comprising the calculated position of the UE.

30. A method of wireless communication at a network entity, comprising:
transmitting, for a user equipment (UE), a Wi-Fi positioning configuration to calculate a position of the UE based on a set of Wi-Fi reference signals (RSs), wherein the Wi-Fi positioning configuration comprises a set of measurement gaps associated with the set of Wi-Fi RSs; and
receiving a report message comprising a calculated position of the UE based on the set of Wi-Fi RSs.
